(19) United States
(12) Patent Application Publication
(10) Pub. No.: US 2015/0025981 A1
(43) Pub. Date: Jan. 22, 2015

(54) URL SHORTENING COMPUTER-PROCESSED PLATFORM FOR PROCESSING INTERNET TRAFFIC

(71) Applicants: David Zaretsky, Chicago, IL (US); Fred Stan Hunting, III, West Simsbury, CT (US); Brandon Guttman, Cincinnati, OH (US)

(72) Inventors: David Zaretsky, Chicago, IL (US); Fred Stan Hunting, III, West Simsbury, CT (US); Brandon Guttman, Cincinnati, OH (US)

(21) Appl. No.: 14/216,495

(22) Filed: Mar. 17, 2014

Related U.S. Application Data
(60) Provisional application No. 61/789,581, filed on Mar. 15, 2013.

(51) Int. Cl. G06F 17/30; G06Q 30/02; H04L 29/08

(52) U.S. Cl. CPC G06F 17/30887; H04L 67/02; G06Q 30/0277; G06F 17/30598
USPC 705/14.73; 707/740

(57) ABSTRACT

A method and system is provided for URL shortening application that allows content publishers to process and monetize traffic through advertising-related data established via a computer network. A computer system may be configured to produce advertisement before redirecting to the destination page. Using certain processing techniques, publishers and related entities may be credited values by the computer system to determine advertisement revenue. Using specialized algorithms, the computer system is optimized to operate more efficiently in processing such data. Because the shortened link is text based, it can also be advantageously configured to be shared on any social media, website, email, text messaging, or other mediums. Advertisements may be displayed any time a shortened link is clicked, so connections with social followers can be achieved through more personal interactions, which are proven to increase click-throughs.

### CROSS-REFERENCE TO RELATED APPLICATIONS

This non-provisional application claims priority to U.S. Provisional Patent Application No. 61/789,581, to Zaretsky et al. titled “URL Shortening Computer-Processed Platform for Processing Internet Traffic Through Advertising Revenue” which was filed on Mar. 15, 2013, and which is incorporated by reference in its entirety herein. This application is also related to U.S. Non-Provisional Patent Application, attorney docket number 61393-705677 to Zaretsy et al., titled “Computer-Based Systems, Apparatuses and Methods for a Social Media Platform for Processing Internet Traffic Through Advertising Revenue” which is filed concurrently with this application and is incorporated by reference in its entirety herein.

### TECHNICAL FIELD

The present disclosure relates to computer systems and more specifically to a computer network for shortening uniform resource locator (URL) data and for processing computer data flows through servers and related web pages.

### BACKGROUND

URL shortening is a technique on the World Wide Web (WWW) in which a Uniform Resource Locator (URL) may be made substantially shorter in length and still direct to the required page. This may be achieved by using an HTTP Redirect on a domain name that is short, which links to the web page that has a long URL. For example, the URL “http://www.example.com/URL-shortening” can be shortened to “http://snip.ps/url”. This is especially convenient for text messaging, emails, blogs, and social media sites where spacing is limited. In particular, social media such as Twitter, severely limit the number of characters that may be used in a message. Using a URL shortener can allow linking to web pages which would otherwise violate this constraint. Short URLs allow otherwise long web addresses to be referred to in a tweet.

There are several reasons to use URL shortening. Often regular unshortened links may be aesthetically unpleasing. Many web developers pass descriptive attributes in the URL to represent data hierarchies, command structures, transaction paths or session information. This can result in URLs that are hundreds of characters long and that contain complex character patterns. Such URLs are difficult to memorize, type-out and distribute. As a result, long URLs must be copied-and-pasted for reliability. Thus, short URLs may be more convenient for websites or hard copy publications (e.g. a printed magazine or a book), the latter often requiring that very long strings be broken into multiple lines (as is the case with some e-mail software or internet forums) or truncated. URL shortening sites also provide detailed information on the clicks a link receives, which can be simpler than setting up an equally powerful server-side analytics engine. However, conventional URL shortening systems have insufficient techniques in which to perform analytics and similarly process shortened URLs along with the associated content to allow content providers to monitor activity.

### SUMMARY

The present disclosure is directed to a URL shortening application that allows content publishers to process and monetize traffic their content generates through advertising revenue established via a computer network. The shortened links are essentially gateways to websites. When a visitor clicks a shortened link, the computer system is configured to produce advertisement before redirecting to the destination page. Using certain processing techniques described below in various embodiments, publishers and related entities may be credited values by the computer system to determine advertisement revenue. Using specialized algorithms, the computer system is optimized to operate more efficiently in processing such data. In one embodiment, after a predetermined period of time (e.g., several seconds), or when a skip button is clicked, the visitor is automatically redirected to the destination website. Because the shortened link is text based, it can be advantageously configured to be shared on any social media, website, email, text messaging, or other mediums. Advertisements may be displayed any time a shortened link is clicked, so connections with social followers can be achieved through more personal interactions, which are proven to increase click-throughs.

Further scope of applicability of the present disclosure will become apparent from the detailed description given hereinafter. However, it should be understood that the detailed description and specific examples, while indicating preferred embodiments, are given by way of illustration only, since various changes and modifications within the spirit and scope of the invention will become apparent to those skilled in the art from this detailed description.

### BRIEF DESCRIPTION OF THE FIGURES

The present disclosure will become more fully understood from the detailed description given herein below and the accompanying drawings which are given by way of illustration only, and thus, do not limit the present disclosure, and wherein:

FIG. 1 illustrates an exemplary computer system under one embodiment comprising a user computer and mobile device operatively coupled to network, which is operatively coupled to a back-end server arrangement and content server;

FIG. 2 illustrates a link shortening process under one exemplary embodiment;

FIGS. 3-4 illustrate exemplary analytics pages for links under one exemplary embodiment;

FIG. 5 illustrates another link shortening process under one exemplary embodiment;

FIG. 6 illustrates an exemplary publishing tool that allow a user to post and schedule messages to any social media from shortened links utilizing a single link or push-button and optionally customize the content and automatically post it to a particular website, social media, email, copy to clipboard, or integrate with third-party tools and user interfaces;

FIG. 7 illustrates an exemplary redirect process for a visitor that clicks on a shortened link under one embodiment;

FIG. 8 illustrates an interactive SVG-based traffic analytics graph to present traffic analytics graphs in an interactive manner under one exemplary embodiment;

FIG. 9 illustrates an exemplary Weibull plot for analytics under one embodiment, where slope of line is e probability of survival, S_{β}, is 36.8 percent at which L/L_{β}=1;

FIG. 10 illustrates an exemplary Weilbull plot for average ads to visits (APV) under one exemplary embodiment;

FIG. 11 illustrates a multi-level referral database that can track the referrals from all users up to any number of levels, wherein the multi-level referral tracks how a user joined a program through referral links, under one exemplary embodiment;

FIGS. 12A-B illustrate various advertising page configurations under various exemplary embodiments;

FIG. 13 illustrates an ad serving methodology under one exemplary embodiment;

FIG. 14 illustrates a string matching process based on the Aho-Corasick pattern matching under one exemplary embodiment; and

FIG. 15 illustrates a bookmarklet to allow users to shorten links remotely without leaving the current website under one exemplary embodiment.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Furthermore, it should be understood by those skilled in the art that, while the present disclosure discusses various embodiments that may include software, each of the embodiments comprising software are configured to operate on a tangible medium, such as a memory. Furthermore, reference is made in this disclosure to concepts, such as monetization, advertisement and the like, which may be interpreted by some as business methods. While in some cases the practice of these concepts provides some business-related benefit, the primary inventive features behind such concepts lie in the techniques and configurations used to more efficiently transfer and process computer data in computer systems.

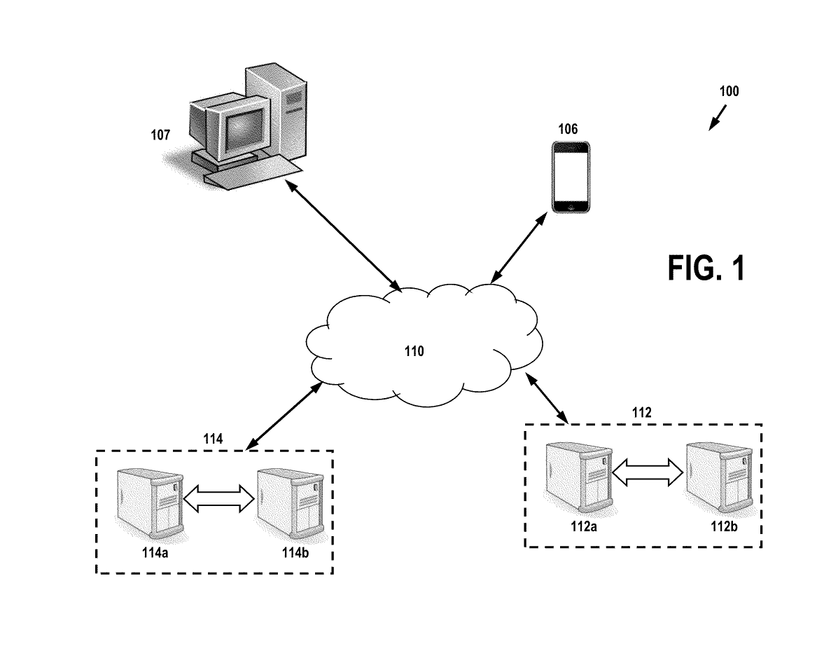

Turning to FIG. 1, an exemplary computer system 100 is disclosed comprising a user computer 107 and mobile device 106 operatively coupled to network 110. Computer 107 may be any suitable device capable of communicating data, such as packet data, over a wired or wireless medium. Examples include, but are not limited to, a personal computer, laptop, or workstation. Mobile device 106 similarly is configured to communicate data over a wired or wireless medium to network 110, and may include such devices as smart phones, tablets, and the like. Network 110 is also operatively coupled to back-end server arrangement 112, which may comprise one or more servers (112a-b) that may be directly linked or linked together via separate networks (e.g., LAN, WAN, etc.). Similarly, Network 110 is also operatively coupled to content server(s) 114, which may comprise one or more servers (114a-b) that may be directly linked or linked together via separate networks (e.g., LAN, WAN, etc.).

Content servers 114 may be configured to provide content (e.g., media, advertisements, text, etc.) requested by one or more users via devices 106-107, or any similar devices that may be in communication with network 110. Back-end server arrangement 112 may be configured in certain embodiments to provide features such as processing link shortening, sharing links, managing links, link redirect process, searching, account management, managing advertisements, traffic analytics, click-through rate processing and analysis, monetization score and rank, processing multi-level referrals, providing ad serving platform, processing targeted advertisements, security features, providing application programming interfaces, which are discussed in greater detail below. Back-end server arrangement 112 may also perform these functions with data from content servers 114. In certain embodiments, back-end server arrangement 112 and content servers 114 may shared responsibility for the aforementioned features. In other embodiments, back-end server arrangement 112 and content servers 114 may be combined into one network to perform all of such features.

Exemplary configurations and platforms described herein are unique from other URL shortening service in that they advantageously allow monetization values to be generated in the computer system to allow revenue for users on the traffic their content generates on social media and the web. In one example, when visitors click on a shortened link, one or more ad impressions of various sizes are displayed to the visitors. The integrated ad serving technology is designed to utilize real-time bidding to maximize the revenue for each ad impression, based on cost-per-thousand (CPM), cost-per-click (CPC), or other factors.

Ad serving technology communicates in real-time with various ad networks, ad exchanges, real-time bidding platforms, and direct advertisers simultaneously, and selects the highest paid advertisements to display to the visitor. The user is paid commission from this advertisement revenue. The monetary compensation from advertisement revenue can also be extended to any sort of consideration, including but not limited to rewards, prizes, coupons, trips, vacations, hotels, and points. Unlike typical banner ads that often go unnoticed, this technology is capable of showing full-page interstitial advertisements that are larger and more visible. This allows advertisement messages to be broadcasted louder and clearer.

The technology also includes an analytics engine, which provides detailed statistics and insight about audience engagement. Analytics as used herein refers to the discovery and communication of meaningful patterns in data. Especially valuable in areas rich with recorded information, analytics relies on the simultaneous application of statistics, computer programming and operations research to quantify performance. Analytics may be applied to computer business data, to describe, predict, and improve business performance, such as optimizing audience engagement, marketing optimizations, price and promotion modeling, predictive science, and fraud analytics.

### Methodology

Generally speaking, URL shortener platforms described herein allow content publishers to get paid for the social value and traffic their content generates through ad revenue. A publisher can share content with his followers or friends using this platform by shortening a link to any content, including but not limited to websites, files, music, images, photos, and videos. The content can be stored on any web domain, cloud server platforms, or any hardware or software physical or abstract medium that can be accessed via any application protocol, including but not limited to HTTP, SSH, TCP/IP, and UDP.

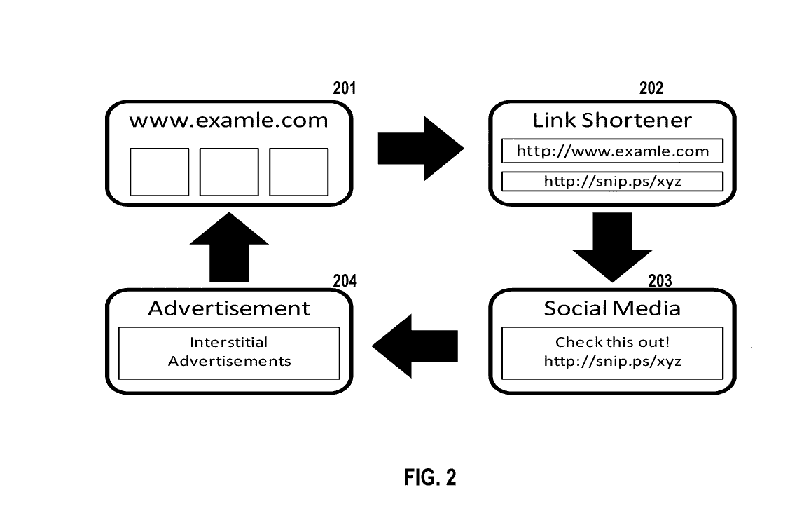

Under one exemplary embodiment illustrated in FIG. 2, a link shorteners maps an original URL 201 to a shorter URL 202 constructed with a tag consisting of a few characters or a custom set of characters, which is appended to the link shortener web domain. The mapping may be stored in a database, such as MySQL, and indexed on the tag name for quick lookup. For instance, the URL http://www.example.com/something/else/file.html, which has 47 characters, can be shortened to http://snip.ps/xyz, which has only 18 characters, saving 29 characters.

Once the link is shortened 202, the publisher can share the shortened link with friends and followers 203. Because the shortened link is string of text (byte) characters it can be shared on any hardware, software, or other medium. This includes but is not limited to any website, social media, email, text messaging, instant messaging, and wired and wireless communication protocols. Furthermore, the text string can be easily converted into other forms of data for sharing through other mediums, including binary data, numerical data, QR codes, serial numbers, and binary or text compression formats.

In one example, when a visitor clicks on a shortened link, they may be taken to a full-page advertisement 204. This may be accomplished generally using an HTTP 301 or 302 redirect protocol. The advertisement can be hosted on any domain or platform. The ad serving technology is optimized to produce the highest paying advertisements by comparing the CPM values returned from various sources, including but not limited to ad networks, ad exchanges, and direct advertisers. The company and publisher earn revenue from these paid ads. After several seconds, or when the skip button is clicked, the visitor is automatically redirected to the destination website, again using an HTTP 301 or 302 redirect protocol.

Under one exemplary embodiment, during a redirect process, analytics are gathered about the visitor. This information is derived from various client data, including but not limited to the IP address, HTTP user-agent, HTTP headers, Ethernet MAC address, and tracking cookies stored in the client's browser. The type of information derived from these data segments include but not limited to the client browser, operating system, application versions, installed programs and application plugins, and referring websites. The IP address is used to perform geo-location lookup for city, state, country, and zip-code. The browser cookies are used to track returning visitors by maintaining a list of tag names for shortened links that a client has visited. If the tag is subsequently found in the cookie when it is read back, it implies they have previously visited that particular link. All of this information is gathered and stored into a database, such as MySQL, and indexed on the tag name for easy look up. The information can then be presented to the user in an easy to read format.

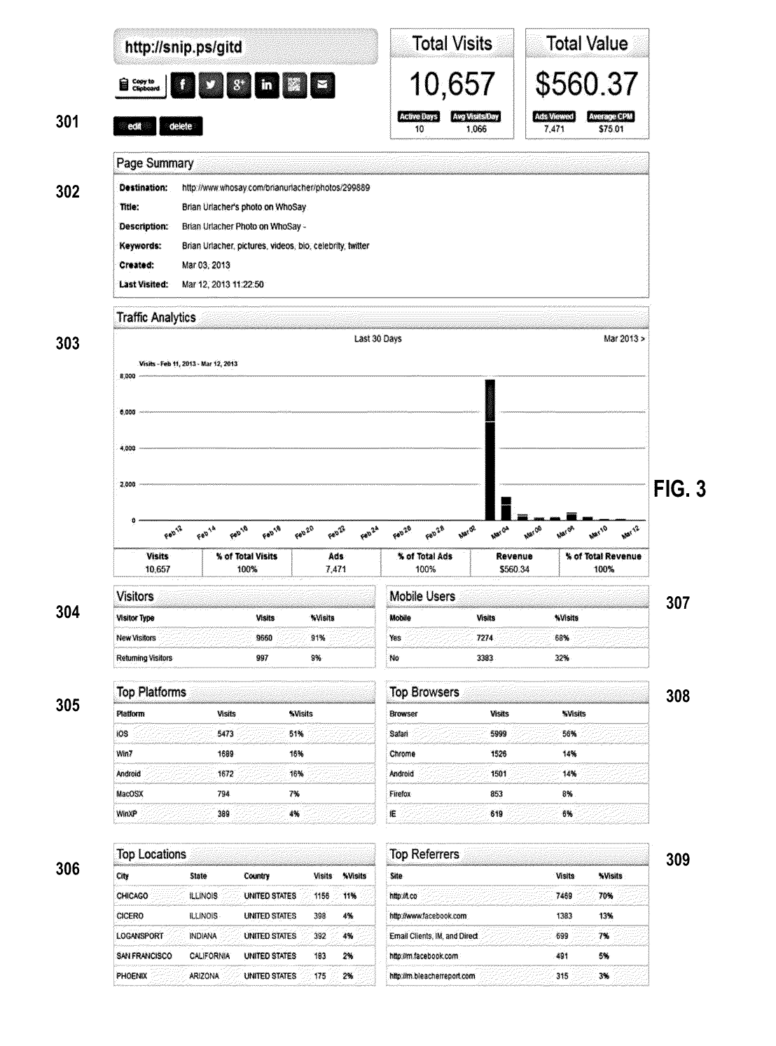

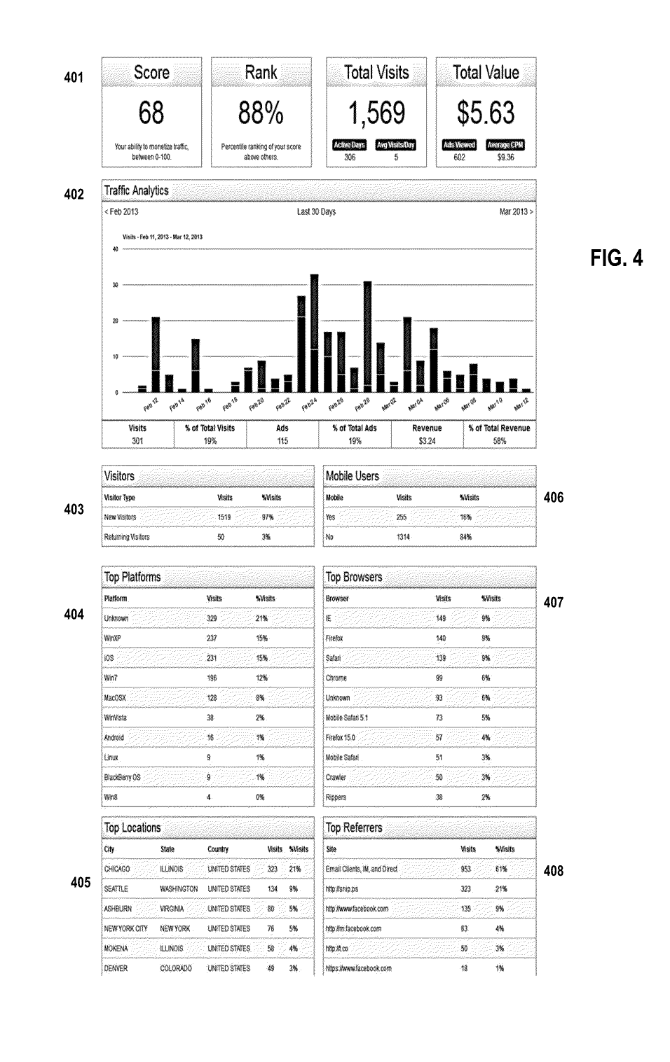

The analytics is presented to the user in real-time as soon as the information is available. The analytics data is acquired on a per-link basis, so there is deeper insight into audience engagement. An example statistics for a particular link is illustrated in FIGS. 3-4, where a heading 301 provides information on a shortened link, together with total visits and total value data. A summary page 302 may also shows combined analytics for all links that belong to a particular user, as illustrated in FIG. 3. The exemplary analytics page may also present traffic analysis (303, 402), visitors (304, 403), top platforms (305, 404), top locations (306, 405) presence of mobile users (307,406), top browsers (308, 407) and top referrers (309, 408). It may also present a users score and rank compared to the rest of the population 401 as shown in FIG. 4.

### (A) Link Shortening Process

In URL shortening, every long URL is associated with a unique key, which is appended to a domain. For example, http://snip.ps/xyz has a key of xyz. When a link is shortened, the data along with information acquired about the landing page is stored in a database. Table 1 provided below presents a list of fields and data types which are used to store the link information in an exemplary MySQL database. One feature of the database is a unique record ID (rid) for each link, which is a serial value that is incremented with each new link. Indexing on numeric data is generally the fastest method for database lookup. Each database entry also include the user ID for the owner of the link, the destination path, the source (tag name) for the shortened link, the timestamp it was created, and the timestamp when it was last accessed. The database is also indexed on the source tag for fast look up.

When a link is shortened or edited, the system downloads from the destination page information about the contents on that page under one exemplary embodiment, which may be used to present to audiences and for targeting advertisement. This may be accomplished using asynchronous multi-threaded processes to acquire the data, which avoids any waiting for the client or system. This downloaded content includes, but not limited to metadata, such as the title of the page, description of the page, keywords, and HTML subject headers (H1, H2, etc). The information may be used to present to visitors about the destination page. It can also be used when sharing the link with others. The data may be also utilized in targeted advertisements based on the context of the landing page, and tracking audience interest by appending the categories and keywords to the client's browser cookies.

TABLE 1
MySQL storage scheme for link shortner database.

| | | | Not | Default |
|---|---|---|---|---|
| Field | Description | Type | Null | Value |
| rid | unique record id | serial | TRUE | 0 |
| uid | user id of owner | int | TRUE | 0 |
| source | source path | varchar(255) | TRUE | Empty |
| destination | redirect URL | varchar(255) | TRUE | Empty |
| created | timestamp of creation | int | TRUE | 0 |
| last_used | timestamp of last use | int | TRUE | 0 |
| custom | Is it a custom tag | int | TRUE | 0 |
| display_ads | Enable or disable | int | TRUE | 1 |
| | advertisements | | | |
| keywords | keywords that describe | text(1024) | TRUE | Empty |
| | destination URL landing | | | |
| | page | | | |
| title | The title of the URL | text(1024) | TRUE | Empty |
| | landing page | | | |
| description | Description of the URL | text(1024) | TRUE | Empty |
| | landing page | | | |
| headers | Headers within the URL | text(1024) | TRUE | Empty |
| | landing page | | | |
| categories | categories that describe | varchar(255) | TRUE | Empty |
| | the destination URL | | | |
| | landing page | | | |

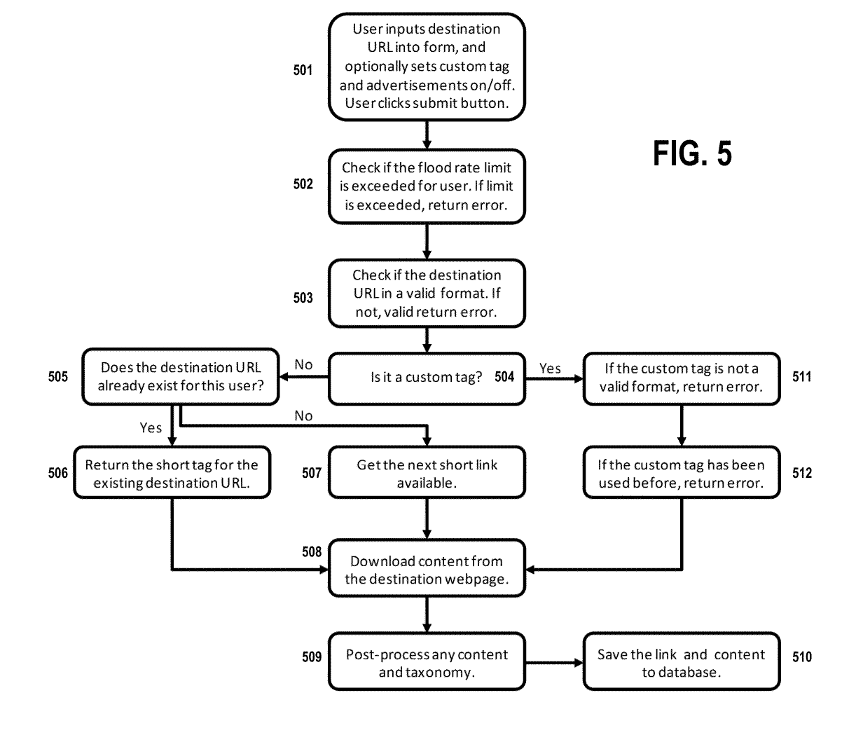

Under one exemplary embodiment, FIG. 5 illustrates an exemplary links shortening process. A form may be used to accept data from the user, which can operate through any static or dynamic software method, including HTML-based scripting languages (HTML, PHP, Javascript, ASP, Ajax, JSONP, Ruby on Rails, etc.), general scripting languages (Perl, Python, Ruby, etc.), compiled software into byte code (C, C++, Java, etc), Java applets, web applications, and mobile software applications. The user inputs a destination URL to the form 501, and optionally sets a custom tag for the shortened URL. The form also allows the user to set advertisements on or off for that particular link. This can be changed at any time.

The system may validate the input data from the form before it is saved. In one exemplary embodiment, flood rate limiting checks 502 if a user has submitted the form too many times in a given time period. A lookup table, illustrated in Table 2, is used to store a unique identifier for a particular user, such on the IP address, and the expiration timestamp. A query may be used to obtain the number of unique events per IP address in a given time frame as follows:

SELECT COUNT(*) FROM table WHERE event = :event AND
identifier = :identifier AND timestamp > :timestamp;

TABLE 2
Flood rate limiting database fields.

| | | | Not | Default |
|---|---|---|---|---|
| Field | Description | Type | Null | Value |
| fid | unique flood id | serial | TRUE | 0 |
| identifier | Identifier of the visitor, | varchar(128) | TRUE | Empty |
| | such as an IP address | | | |
| | or hostname. | | | |
| expiration | expiration timestamp. | int | TRUE | 0 |
| | Expired events are | | | |
| | purged on cron run. | | | |

The format of the destination URL is also checked that it is a valid path 503, for example, that it begins with http:// and www headers, or the inclusion of invalid characters, such as spaces. If a custom tag is supplied 504, it is checked to see if the string is valid and whether the tag has been previously used. If so, it may return an error or an alternative suggestion 511-512. All tags may be case sensitive in order to allow the greatest number of possible unique matches. Valid characters include any alphanumeric character, underscore, and hyphen, resulting in 255⁶⁴ possible combinations. The system can look up a case-sensitive source from the MySQL database using the query: SELECT * FROM table WHERE BINARY source=: tag.

If no custom tag is supplied, the system finds the next shortest tag via 505-506. The default tag is a set of randomized alphanumeric characters that does not contain any vowels in order to avoid complete words. This results in 52 unique characters, and at most 255⁵² possible unique combinations. The system may begin with a single character and additional characters are appended as needed. A counter is used to track the last sequence used. Before getting the next shortest tag, the system checks to see if the user has previously created a short link to the same destination address 505. If so, that short link is returned 507. Retrieving a source for an existing destination URL created by a particular user can be accomplished by using a case-sensitive lookup form the MySQL database as follows:

SELECT source FROM table WHERE destination = :long AND uid =
:uid ORDER BY rid DESC.

Once the tag has been validated, the system downloads data from the destination website using asynchronous multi-threaded processes, including but not limited to meta-data, such as the title of the page, description of the page, keywords, and HTML subject headers (H1, H2, etc). Together, this content provides a good summary of the context of the web page.

Post processing is then performed on the downloaded content 508, such as identifying taxonomy keywords and categorizing the content 509 for subsequent storage 510. The system may scan the content for inappropriate or illegal material, such as adult content and illegal file sharing based on keyword matching. It also may scan the destination web page for active threats, such as malware and viruses, by lookup of the domain or address in a database or through third-party tools. If the page is flagged for inappropriate content or active threats, the link may be automatically disabled.

The input data from the user, along with this information is stored to the database, and indexed on a new unique identifier (rid). The form returns the shortened URL to the user, which can then be shared with audiences anywhere.

### (B) Sharing Links

Shortened links can be shared with audiences in any number of ways. Examples include copying to the operating system's clipboard, posting the links to websites, forums, blogs, social media, texting, and emailing. The shortened links can also be transformed into other mediums that can be read with new tools in the future. For instance, the links can be transformed into bar codes or Quick Response (QR) codes, which is a two-dimensional bar code. A QR code is read by an imaging device, such as a camera, and formatted algorithmically by underlying software using Reed-Solomon error correction until the image can be appropriately interpreted. Data is then extracted from patterns present in both horizontal and vertical components of the image. As an example, a shortened link can be stored as a QR code and read by a mobile device equipped with a camera, which will open the URL and redirect the visitor to the advertisement and subsequently the destination web page.

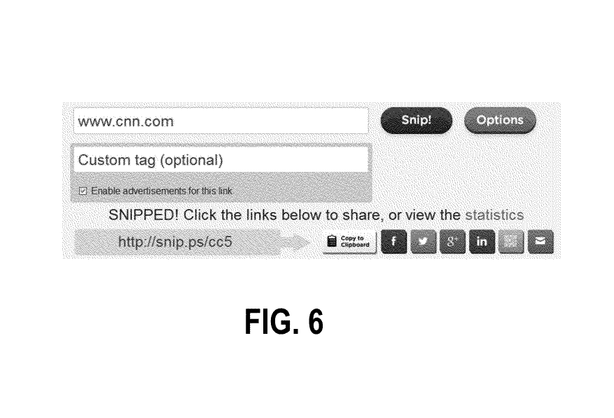

The exemplary shortening application is built with a set of publishing tool(s) that allow the user to seamlessly post and schedule messages to any social media, either independently or all at once. FIG. 6 illustrates how a user can click a single link or push a button in software, hardware, or on any medium to optionally customize the content and automatically post it to a particular website, social media (e.g. Facebook, Twitter, Google Plus, LinkedIn), email, copy to clipboard, or integrate with third-party tools and user interfaces.

### (C) Managing Links

A user has the ability to manage, edit, and customize his links any time, including:
1. The ability to edit the destination URL. When this occurs, the information and metadata from the new destination website may be downloaded and updated into the database through an asynchronous multi-threaded process. This includes the new title, description, keywords, and headers. Any post processing on this content, such as identifying taxonomy keywords and categorizing the content, also occurs once the new content has been downloaded.
2. Enabling or disabled advertisements per each link. If advertisements are disabled, the any visitor that clicks on a link is redirected to the destination page without seeing an advertisement. The user does not receive revenue because no advertisements are shown.
3. Deleting links. This will delete all content and analytics associated with this link.
4. Change the title and description of a link. This will override the downloaded content from the destination webpage. One may also have the option to edit other content, such as keywords and categories.

### (D) Link Redirect Process

When a visitor clicks on a shortened link, they are redirected to an advertisement for several seconds, before automatically redirecting to the destination page. The redirection instruction sent to a browser can contain in its header the HTTP status 301 (permanent redirect), 302 (redirect for unspecified reason), or 307 (temporary redirect). The redirecting instruction can be implemented using a server side scripting language, such as PHP, or a client side scripting language, such as Javascript. This latter technique is utilized in conjunction with a countdown timer to automatically redirect the browser after several seconds of displaying an advertisement by reassigning the browser URL in the address bar, as illustrated in [EX1], found belowError! Reference source not found.

var time_left = 10;
var timer;
function time_dec( )
{

time_left--;

document.getElementById(“countdown”).innerHTML =
time_left;

if(time_left == 0)
{

window.location.href =

“http://cnn.com”;

clearInterval(timer);

}

}
timer = setInterval(“time_dec( )”, 1000);

[EX1]: Javascript Code that Redirects Client's Browser after 10 Sec Countdown Timer Reaches Zero.

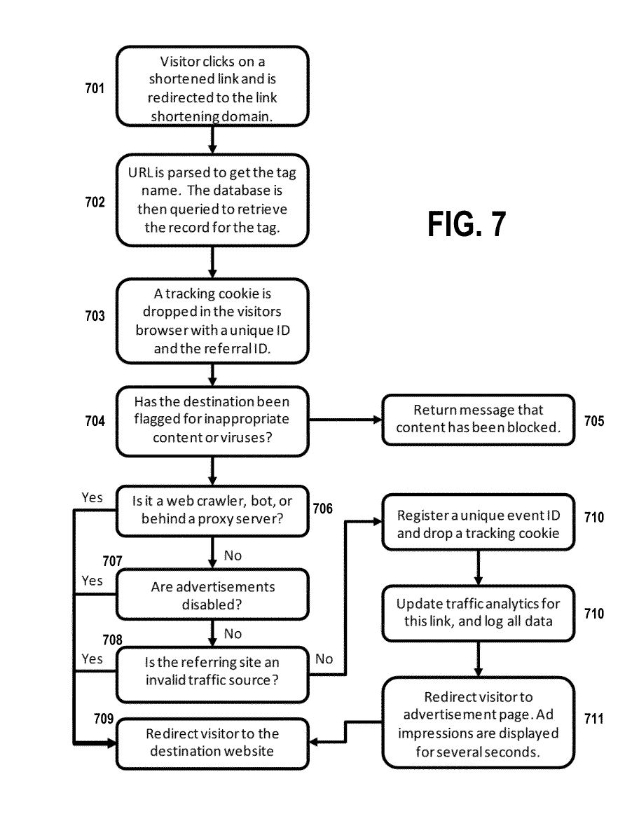

An exemplary redirect process is illustrated further in FIG. 7. Here, a visitor clicks on a shortened link and is first redirected to the link shortening domain 701. The software application parses the URL and extracts the shortened name 702. For instance, if the shortened link was http://snip.ps/xyz, then the parser would extract xyz. Based on the shortened tag name, the application performs a case-sensitive (binary) database lookup to retrieve the corresponding record using the following query:

SELECT * FROM table WHERE BINARY source=:tag;

Next, a tracking cookie is deposited in the client's browser with a unique identifier 703, which allows the software to track the user if they should return. The referral ID is also deposited into the cookie, which contains the user referral ID for the owner of the link. Should the client sign up within the expiration time of the referral cookie, they automatically become a referral of that user.

Before redirecting to the page, security checks are implemented. If the content has been flagged for inappropriate content 704, such as adult material, or the destination site has active viruses or malware, the client is redirected to a “blocked-content” page 705. The system may also screen out web crawlers, bots, clients behind a proxy server, and invalid traffic sources such as traffic exchanges 706-708. All of this information can be derived from behavior monitoring, content matching, database lookups, or third-party tool integration. In order to prevent fraud and abuse, if any of these checks turn out positive, the client bypasses the advertisement and is redirected to the destination page 709.

TABLE 3
Database table entries for Global Unique Identifiers to track ad

| | | | Not | Default |
|---|---|---|---|---|
| Field | Description | Type | Null | Value |
| guid | Global unique event ID | varchar(128) | TRUE | Empty |
| uid | User ID of the URL owner. | int | TRUE | 0 |
| ip | IP address of the visitor | varchar(128) | TRUE | Empty |
| source | Source (shortened) tag | varchar(255) | TRUE | Empty |
| | name | | | |
| rid | Unique record ID | int | TRUE | 0 |
| expiration | Expiration timestamp. | int | TRUE | 0 |
| | Expired events are purged | | | |
| | on cron run. | | | |

If all security checks pass, a Global unique event ID (GUID) is created and added as database entry, as described above in Table 3. The GUID is passed with the URL string during the redirect process. It is also deposits as a cookie in the client's browser to track each visitor 710, and to determine if cookies are enabled in their browser.

The system then uses the client IP address, HTTP user-agent, and referring URL to gather information about the client 710. This information includes but is not limited to browser, operating system, referring website, and geolocation. The traffic analytics data is then stored to the database.

Finally, the client is redirected to the advertisement page 711. The user gets paid from the ad revenue generated by the ad impressions displayed to the client. The ad can be skipped by the client any time, or he is automatically redirected after several seconds to the landing page.

### (E) Searching

The ability to explore an entire collection of all shortened links and the content they represent can be accomplished using a search query mechanism. The search query can be matched against the destination URL string and all metadata and content that was downloaded from the website, including but not limited to the title, description, keywords, and headers. A list of taxonomy keywords may also be generated as well as categories from this content, which can be more easily searched. An example search query can be applied to a MySQL database with the following statement:

SELECT * FROM table WHERE destination LIKE “%query%” OR
description LIKE “%query%” OR keywords LIKE “%query%”
OR headers LIKE “%query%”;

### (F) Account Management

A user account may include various fields to better identify a person and their followers. It may also help in generating analytics and optimizing targeted advertisements by determining the demographics of a person and/or their followers. For instance, an age range, gender, and likes. The user account includes but is not limited to the following:

1. User ID

2. Email address

3. Profile picture

4. Sign up for newsletters and updates

5. Mailing address

6. Phone number

7. Preferred payment method

8. Gender

9. Age

10. Demographics of followers

11. Social media handles

12. OAuth access to social media to obtain their number of followers

13. Ad management controls

### (G) Managing Advertisements

A user account may include various fields to better identify a person and their followers. It also helps in generating analytics and optimizing targeted advertisements by determining the demographics of a person and/or their followers. For instance, their age range, gender, and likes. From this account, a user can manage advertisements on each link, including:
1. Enabling or disabling advertisements for all links. This will override the settings for individual links. If disabled, then a client that clicks on a shortened link will not see any advertisements.
2. Enabling or disabling non-branded ad campaigns. If non-branded ad campaigns are disabled, run-of-network advertisements are never included in the real-time bidding for ad impressions, and these advertisements are never displayed to visitors. Rather, only branded ad campaigns that are specifically set up to target this individual are displayed. If a branded ad campaign is not available, no ad impression is displayed to the visitor.
3. Enabling or disabling rich-media advertisements only. If enabled, text-based advertisements will not show. Rather only high quality images and animated advertisements (such as Flash or GIF) are displayed.
4. Enabling or disabled specific networks. The user can choose to allow only advertisements from specific ad networks, ad exchanges, or direct advertisers.
5. Specifying categories. The user can select certain categories of targeted advertisements for his audience to display or not to display. For instance, one may wish to only display ads pertaining to cars for his audience. Or, one may wish to not have ads displayed about certain subject matters.

### (H) Traffic Analytics

The traffic analytics engine provides powerful real-time analytics and insight to gauge audience reach. The analytics are attributed to each link independently to provide more fine-grain insight into the audience engagement. The traffic analytics may be derived from various data points including the IP address, HTTP user-agent, and HTTP referring website. The following exemplary methods may be used to acquire data for the traffic analytics:
1. HTTP_REFERER—When visiting a webpage, the referrer or referring page is the URL of the previous webpage from which a link was followed. This data is acquired from the HTTP header field, HTTP_REFERER.
2. HTTP_USER_AGENT—When a software agent operates in a network protocol, it often identifies itself, its application type, operating system, software vendor, or software revision, by submitting a characteristic identification string to its operating peer. In HTTP protocols, this identification is transmitted in a header field HTTP_USER_AGENT. One may utilize the Browscap module (http://browscap.org/) to download and maintain a local active MySQL database of all known user agents. The Browscap data is already parsed to include information such as operating system, browser, versions, web crawlers, bots, and mobile platforms. A match can be found very quickly by querying the database as follows:

SELECT * FROM {browscap} WHERE :useragent LIKE useragent
ORDER BY LENGTH(useragent) DESC

3. IP ADDRESS—Geolocation lookup is used to deduce the geographic location of a visitor to a website. The approach is to use the client's IP address to look up their location through a database or third-party query tool. There are a number of free and paid subscription geolocation databases, ranging from country level to state or city—including ZIP/post code level—each with varying claims of accuracy (generally higher at the country level). One may utilize this method to obtain the Country, State, and City for each visitor to a particular link.

The storage method for the traffic analytics engine is described in

Table 4 through Table 15 below. These methods can be extended to store information about other traffic demographics, such as age, gender, and click-through rates. The tables are organized to provide optimal functionality in storing and retrieving the analytics data, as follows:
1. Paths—
2. Table 4 maps a shortened link's record ID, or path ID (pid) to its shortened tag name. It also includes a reference to the user ID. Given a shortened tag name (path), the pid can be retrieved with the following query:

SELECT pid FROM {traffic_analytics_paths} WHERE BINARY path =
:path

3. Summary—
4. Table 5 maps a path ID to the total number of visits, ad impressions displayed, and total revenue for that particular link. From this data, one can derive the average daily visits since the creation of the link (visits/days), and the average cost-per-thousand ad impressions (value*1000/ads). Given the pid, these values can be retrieved with the following query:

SELECT visits, ads, value FROM {traffic_analytics_summary}
WHERE pid = :pid

5. Visits—Table 6 maps a path ID to the total number of visitors for that particular link on any given date. Given the pid, the number of visits can be retrieved with the following query:

SELECT count FROM {traffic_analytics_visits} WHERE pid =
:pid AND date = :date

6. Returning Visitors—
7.
8. Table 7 maps a path ID to the total number of returning visitors for that particular link. Given the pid, the number of returning visitors can be retrieved with the following query:

SELECT count FROM {traffic_analytics_returning_visitors}
WHERE pid = :pid

9. Mobile—Table 8 maps a path ID to the total number of mobile users for that particular link. Given the pid, these values can be retrieved with the following query:

SELECT count FROM {traffic_analytics_mobile} WHERE pid =
:pid

10. Ads—Table 9 maps a path ID to the total number of ad impressions displayed and revenue earned for that particular link on any given date. Given the pid, these values can be retrieved with the following query:

SELECT count, value FROM {traffic_analytics_ads} WHERE pid =
:pid AND date = :date

11. Platforms—Table 10 maps a path ID to the various operating systems utilized by visitors to that particular link. Given the pid, the top values can be retrieved with the following query:

SELECT os, mobile, count FROM {traffic_analytics_platforms}
WHERE pid = :pid ORDER BY count DESC

12. Browsers—
13.
14. Table 11 maps a path ID to the various web browsers utilized by visitors to that particular link. Given the pid, the top values can be retrieved with the following query:

SELECT browser, bot, count FROM
{traffic_analytics_browsers} WHERE pid = :pid ORDER BY
count DESC

15. Locations—Table 12 maps a path ID to the geolocations (city, state, country) for visitors to that particular link. Given the pid, the top values can be retrieved with the following query:

SELECT city, state, country, count FROM
{traffic_analytics_locations} WHERE pid = :pid ORDER BY
count DESC

16. Referring Websites—Table 13 maps a path ID to the top referring websites for that particular link. Given the pid, the top values can be retrieved with the following query:

SELECT referrer, count FROM {traffic_analytics_referrers}
WHERE pid = :pid ORDER BY count DESC

17. Top Daily Visits—Table 14 maps a path ID to the total number of visits for that particular link each day. This method can be used to promote the top visited links. Given the pid, these values can be retrieved with the following query:

SELECT * FROM {traffic_analytics_top_daily_visits} WHERE
date >= :start AND date <= :end ORDER BY count DESC

18. User Summary—Table 15 maps a user ID to the total number of visits, ad impressions displayed, and revenue for that particular user. It also holds the score and rank of that user as compared with the entire population. Given the uid, these values can be retrieved with the following query:

SELECT visits, ads, value, score, rank FROM
{traffic_analytics_users} WHERE uid = :uid

19. Population Statistics—Table 16 stores the median score and rank for the population each day. Given a date, these values can be retrieved with the following query:

SELECT score, rank FROM
{traffic_analytics_population_stats} WHERE date = :date

TABLE 4
Database field entries for Traffic Analytics Paths

| | | | | Default |
|---|---|---|---|---|
| Field | Description | Type | Not Null | Value |
| pid | Unique path ID | Int | TRUE | 0 |
| uid | Unique user ID | Int | TRUE | 0 |
| path | Path | varchar(255) | TRUE | Empty |

TABLE 5
Database field entries for Traffic Analytics Summary

| | | | | Default |
|---|---|---|---|---|
| Field | Description | Type | Not Null | Value |
| pid | Unique path ID | int | TRUE | 0 |
| visits | Total number of visits | int | TRUE | 0 |
| ads | Total number of advertisements | int | TRUE | 0 |
| value | Total earnings from advertisements | float | TRUE | 0 |

TABLE 6
Database field entries for Traffic Analytics Visits

| | | | | Default |
|---|---|---|---|---|
| Field | Description | Type | Not Null | Value |
| pid | Unique path ID | int | TRUE | 0 |
| date | Timestamp for date of visit | int | TRUE | 0 |
| count | Counter for number of visits | int | TRUE | 0 |

TABLE 7
Database field entries for Traffic Analytics Returning Visitors

| | | | | Default |
|---|---|---|---|---|
| Field | Description | Type | Not Null | Value |
| pid | Unique path ID | Int | TRUE | 0 |
| count | Counter for number of returning | Int | TRUE | 0 |
| | visitors | | | |

TABLE 8
Database field entries for Traffic Analytics Mobile Platforms

| | | | | Default |
|---|---|---|---|---|
| Field | Description | Type | Not Null | Value |
| pid | Unique path ID | Int | TRUE | 0 |
| count | Counter for number of mobile users | int | TRUE | 0 |

TABLE 9
Database field entries for Traffic Analytics Ads

| | | | | Default |
|---|---|---|---|---|
| Field | Description | Type | Not Null | Value |
| pid | Unique path ID | int | TRUE | 0 |
| date | Timestamp for ad displayed | int | TRUE | 0 |
| count | Counter for number of ads | int | TRUE | 0 |
| value | Sum of earnings from ads | float | TRUE | 0 |

TABLE 10
Database field entries for Traffic Analytics Platforms

| | | | | Default |
|---|---|---|---|---|
| Field | Description | Type | Not Null | Value |
| pid | Unique path ID | int | TRUE | 0 |
| os | Operating system | varchar(64) | TRUE | Empty |
| mobile | Is it a mobile OS | int | TRUE | 0 |
| count | Counter for platforms | int | TRUE | 0 |

TABLE 11
Database field entries for Traffic Analytics Browsers

| | | | | Default |
|---|---|---|---|---|
| Field | Description | Type | Not Null | Value |
| pid | Unique path ID | int | TRUE | 0 |
| browser | Browser | varchar(64) | TRUE | Empty |
| bot | Is it a web crawler or bot | int | TRUE | 0 |
| count | Counter for platforms | int | TRUE | 0 |

TABLE 12
Database field entries for Traffic Analytics Locations

| | | | | Default |
|---|---|---|---|---|
| Field | Description | Type | Not Null | Value |
| pid | Unique path ID | int | TRUE | 0 |
| city | City | varchar(64) | TRUE | Empty |
| state | State or Region | varchar(64) | TRUE | Empty |
| country | Country | varchar(64) | TRUE | Empty |
| count | Counter for platforms | int | TRUE | 0 |

TABLE 13
Database field entries for Traffic Analytics Referers

| | | | | Default |
|---|---|---|---|---|
| Field | Description | Type | Not Null | Value |
| pid | Unique path ID | int | TRUE | 0 |
| referrer | Referral URL or Domain | varchar(255) | TRUE | Empty |
| count | Counter for number of | int | TRUE | 0 |
| | referrers | | | |

TABLE 14
Database field entries for Traffic Analytics Top Daily Visits

| | | | | Default |
|---|---|---|---|---|
| Field | Description | Type | Not Null | Value |
| pid | Unique path ID | int | TRUE | 0 |
| date | Timestamp for date of visit | int | TRUE | 0 |
| count | Counter for number of visits | int | TRUE | 0 |

TABLE 15
Database field entries for Traffic Analytics Users

| | | | | Default |
|---|---|---|---|---|
| Field | Description | Type | Not Null | Value |
| uid | Unique user ID | int | TRUE | 0 |
| visits | Total number of visits | int | TRUE | 0 |
| ads | Total number of advertisements | int | TRUE | 0 |
| value | Total earnings from advertisements | float | TRUE | 0 |
| score | Score in terms of ability to monetize | int | TRUE | 0 |
| rank | Rank in terms of revenue earned | int | TRUE | 0 |

TABLE 16
Database field entries for Traffic Analytics Population Statistics

| | | | | Default |
|---|---|---|---|---|
| Field | Description | Type | Not Null | Value |
| date | Timestamp for ad displayed | int | TRUE | 0 |
| score | Score in terms of ability to monetize | int | TRUE | 0 |
| rank | Rank in terms of revenue earned | int | TRUE | 0 |

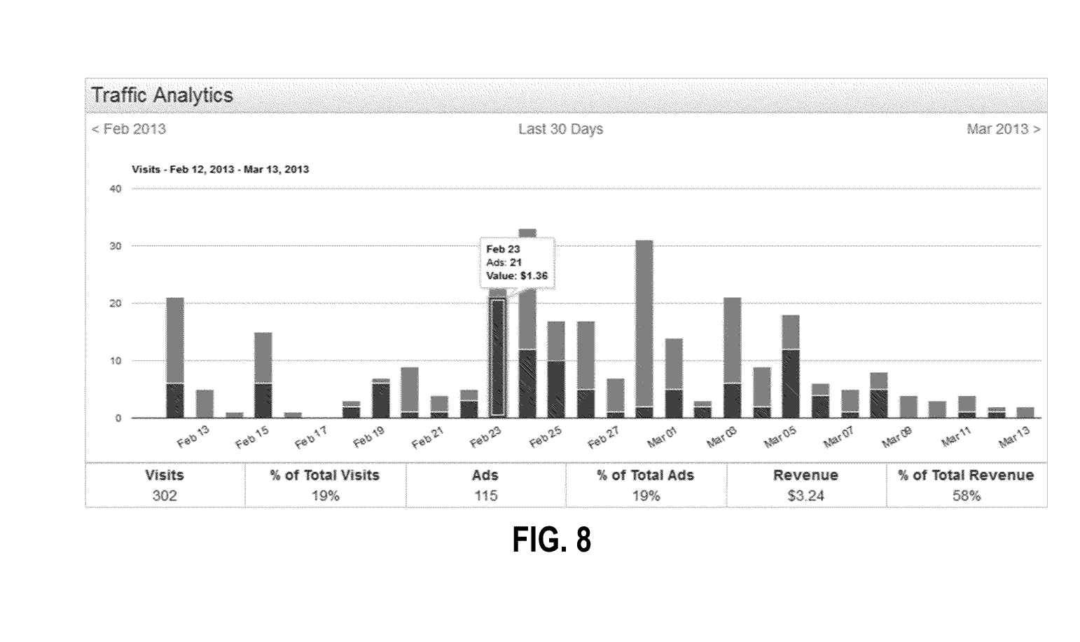

The methods described above are utilized to generate a traffic analytics report for each link, as illustrated in FIGS. 2-3 (303, 402). In addition, Scalable Vector Graphics (SVG) may be utilized to present the traffic analytics graphs in an interactive manner. SVG is an XML-based vector image format for two-dimensional graphics that has support for interactivity and animation. There are various methods to generate graph, either using a software program or by using third party tools, such as Google's Charts API. FIG. 8 demonstrates an exemplary traffic analytics interactive graph. The number of daily ad impressions and total revenue is overlaid on top of the total daily visits. By clicking on the bar, a pop-up window specifies the number of ads, the revenue, and the visits for that day. To generate this graph, one may utilize the code base demonstrated in [EX2] below. One manner for making the ads overlay the visits is by subtracting the ads from the visits in order to reduce the value, v, but the actual text field, f, is specified as the original value. For example, on February 23 there were 27 visits and 21 ad impressions. The visits value is set to v=27-21=6, while the text field is set to f=27.

One can navigate to any time frame in the graph by clicking a date range button, hyperlink, or navigation tab. The plot can be viewed by year, month, week, day, hour, minute, or second, depending on the level of fine grain detail stored in the database. This system may store long-term analytics data at the level of days, but also may maintain a separate table to store data for the current day only at the level of seconds. This allows a user to zoom in and out to various date and time ranges. The tables holding the data at the level of seconds is eliminated each day. A period summary is also shown, which breaks down the number of visits, ad impressions, and revenue for that time period.

google.load(“visualization”, “1.0”, “packages”:[“corechart”]});
google.setOnLoadCallback(drawChart) ;
function drawChart( ) {
var data = google.visualization.arrayToDataTable([

[“Date”, “Ads”, “Visits”], [“”, 0, 0],
[“Feb 12”, {v:6, f:“6\nValue: $0.02”}, {v:15, f:“21”}],
[“Feb 13”, 0, 5],
[“Feb 14”, 0, 1],
[“Feb 15”, {v:6, f:“6\nValue: $0.03”}, {v:9, f:“15”}],
[“Feb 16”, 0, 1],
[“Feb 17”, 0, 0],
[“Feb 18”, {v:2, f:“2\nValue: $0.01”}, {v:1, f:“3”}],
[“Feb 19”, {v:6, f:“6\nValue: $0.03”}, {v:1, f:“7”}],
[“Feb 20”, {v:1, f:“1\nValue: $0.00”}, {v:8, f:“9”}],
[“Feb 21”, {v:1, f:“1\nValue: $0.00”}, {v:3, f:“4”}],
[“Feb 22”, {v:3, f:“3\nValue: $0.01”}, {v:2, f:“5”}],
[“Feb 23”, {v:21, f:“21\nValue: $1.36”}, {v:6, f:“27”}],
[“Feb 24”, {v:12, f:“12\nValue: $0.90”}, {v:21, f:“33”}],
[“Feb 25”, {v:10, f:“10\nValue: $0.68”}, {v:7, f:“17”}],
[“Feb 26”, {v:5, f:“5\nValue: $0.02”}, {v:12, f:“17”}],
[“Feb 27”, {v:1, f:“1\nValue: $0.00”}, {v:6, f:“7”}],
[“Feb 28”, {v:2, f:“2\nValue: $0.01”}, {v:29, f:“31”}],
[“Mar 01”, {v:5, f:“5\nValue: $0.02”}, {v:9, f:“14”}],
[“Mar 02”, {v:2, f:“2\nValue: $0.01”}, {v:1, f:“3”}],
[“Mar 03”, {v:6, f:“6\nValue: $0.03”}, {v:15, f:“21”}],
[“Mar 04”, {v:2, f:“2\nValue: $0.01”}, {v:7, f:“9”}],
[“Mar 05”, {v:12, f:“12\nValue: $0.05”}, {v:6, f:“18”}],
[“Mar 06”, {v:4, f:“4\nValue: $0.02”}, {v:2, f:“6”}],
[“Mar 07”, {v:1, f:“1\nValue: $0.00”}, {v:4, f:“5”}],
[“Mar 08”, {v:5, f:“5\nValue: $0.02”}, {v:3, f:“8”}],
[“Mar 09”, 0, 4],
[“Mar 10”, 0, 3],
[“Mar 11”, {v:1, f:“1\nValue: $0.00”}, {v:3, f:“4”}],
[“Mar 12”, {v:1, f:“1\nValue: $0.00”}, {v:1, f:“2”}],
[“Mar 13”, 0, 2]]);
DrawChart = function ( w, h, cw, ch, l, hfs, sp )
{

var options = {

title: “Visits - Feb 12, 2013 - Mar 13, 2013”,
width: w,
height: h,
chartArea: {width:cw,height:ch,left:l},
fontSize: 10,
legend: “none”,
colors: [“green”, “blue”],
isStacked: true,
axisTitlesPosition: “none”,
hAxis: {slantedText: true, minValue: 0, showTextEvery:
sp, textStyle: {fontSize: hfs}},
vAxis: {viewWindow: {min: 0}}

};
var chart = new
google.visualization.ColumnChart(document.getElementBy
Id(“analytics-chart-div”));
chart.draw(data, options);

}

}

[EX2]: Google Charts API code for Traffic Analytics Graph

### (I) Click-Through Rate

In one exemplary embodiment, click-through rates (CTR) can be determined if a user supplies their account credentials to a social media site, such as Facebook or Twitter, using the OAuth method, for instance. The system can then acquire the total number of social followers for each social media. When a shortened link is posted to one of these sites, the referral websites will accumulate in the traffic analytics. The click-through rate may then be defined for a particular link as: CTR=R/N, where R is the number of times the social media domain appeared as the referring website for this link in the database (Table 13), and N is the number of social followers for that user on that social media site. This information may also be used to obtain an average CTR for all social media, as well as an average CTR for all links for a particular user.

### (J) Monetization Score and Rank

There are many industry platforms available that asses an individual's ability to influence others and platforms that determine the popularity of websites:

Alexa Rank (www.alexa.com) provides traffic data, global rankings, and other information about websites to determine its popularity. Once it is installed, the Alexa Toolbar collects data on browsing behavior and transmits it to the Alexa website, where it is stored and analyzed, forming the basis for the company's web traffic reporting. As of 2013, Alexa provides traffic data, global rankings and other information on 30 million websites, and claims that 6 million people visit its website monthly

PageRank is a link analysis algorithm by the Google (www.google.com) web search engine that assigns a numerical weighting to each element of a hyperlinked set of documents on the internet, with the purpose of measuring its relative importance within the set. The algorithm may be applied to any collection of entities with reciprocal quotations and references.

The Klout score (www.klout.com) provides social media analytics to measure a user's influence across his or her social network. The analysis is done on data taken from sites such as Twitter, Facebook, and Google+, and measures the size of a person's network, the content created, and purports to measure how other people interact with that content. Klout scores range from 1 to 100, with higher scores corresponding to a higher assessment by Klout of the breadth and strength of one's online influence. Klout scores are supplemented with three nominally more specific measures, which Klout calls “true reach,” “amplification,” and “network impact.” True reach is based on the size of a person's “engaged audience” of followers and friends who actively listen and react to his or her online messages. Amplification score relates to the likelihood that one's messages will generate actions (retweets, messages, likes, and comments). Network score reflects the computed influence value of a person's engaged audience.

Kred Influence Measurement, or Kred, (www.kred.com) is a measure of influence created by PeopleBrowsr, a San Francisco-based social media analytics company, to identify influential people in interest-based communities. Kred scores are generated by observing a social network user's content, who it reaches, who acts upon it, and whether the user relays the content of others. Kred is given as a dual score to distinguish a person's Influence (the likelihood that someone will trust a person and act upon their posts) and Outreach (the propensity to share other people's content forward). Kred Influence measures a user's relative ability to inspire action from others like retweeting, replies, or new follows. Influence scores are delivered on a normalized 1,000 point scale with higher scores representing a higher degree of trust and influence within the network. Kred Outreach measures generosity and rewards actions like engagement with others and willingness to spread their message. Outreach is scored in ever-increasing levels and never decreases.

Peerindex (www.peerindex.com) is a London-based company providing social media analytics based on footprints from use of major social media services (currently Twitter, LinkedIn, Facebook and Quora). Part of an emerging group of Social Media Analytics providers, Peerindex helps social media contributors assess and score their influence and benefit from the social capital they have built up. Peerindex currently tracks 45 million Twitter profiles, making the company one of the leaders in its sector.

Q Score (www.qscores.com) is a measurement of the familiarity and appeal of a brand, company, celebrity, or television show used in the United States. The higher the Q Score, the more highly regarded the item or person is among the group that is familiar with them. Q Scores and other variants are primarily used by the media, marketing, advertising and public relations industries.

The URL shortener technology disclosed herein is the first to introduce a Monetization Score and Rank which are used to calculate a user's ability to monetize traffic on the internet and social media. Because the advertisement revenue is directly correlated to the traffic generated by each link, one can accurately determine how well an individual can monetize traffic. While the other methods listed above evaluate individuals independently of others, this method calculates an individual's score based on how well the rest of the population performed. The reason for this is that there are many factors in the environment and economics that can change the behavior of entire populations. A score is more meaningful if an individual can assess how they are doing as compared with everyone else. Therefore, one may utilize the percentile rank of an individual's score in various test factors to calculate the complete monetization score.

An exemplary monetization score may be calculated over each 30 day period in one example, based on several weighted test factors, including (but not limited to):
R, the total revenue earned. This determines how well an individual performed in generating revenue over a 30 day period.
V, the average number of daily visits over a 30 day period. This measures the overall daily activity of an individual.
CPM, the average cost-per-thousand ad impressions (CPM=revenue*1000/ads). The CPM is directly correlated to the interest level of the content being shared, since advertisers are generally more inclined to pay higher CPMs for relevant topics. Also, celebrities and athletes that have branded advertisements will earn higher CPMs.
APV, the average number of ads per visit (APV=ads/visits). The use of bots or web crawlers would not generate paid advertisements. Likewise, introducing software programs to click links would also not generate paid advertisements. In effect, these schemes would increase the number of visits, but not the number of advertisements, and therefore would reduce the APV.

Each of these values may be calculated for every individual in the population, and then given a rank, r, based on its percentile rank from 0-100%. A fractional weight, w, is then applied to each value and added together to receive the monetization score. The sum of all weights must equal 1.0, and they can be evenly distributed, or more heavily weighted on certain factors. Other factors can be added to the score as well, and then simply adjusting the weights. The monetization score, S, may be defined as:

S=w_{R}*r_{R}+wᵥ*rᵥ+w_{CPM}*r_{CPM}+w_{APV}*r_{APV},
Where, w_{R}+w_{V}+w_{CPM}+w_{APV}=1

The monetization score can be calculated by first updating the analytics for each individual over a 30-day period, as described in [EX3] below. The data is a summation of all visits, ad impressions displayed, and revenue generated. In [EX4], the score is calculated for each factor as described above, and then ranked based on percentile within the entire population. One may consider those individuals with no traffic or revenue as suspensions and are not evaluated in the score. Each factor then has a rank value between 0-100. In this case, an evenly distributed weight of 0.25 is applied to each rank value. The resulting monetization score is a value between 0-100. Finally, in [EX5], the percentile rank of the monetization score is calculated for each individual.

INSERT INTO {traffic_analytics_users } (uid, visits, ads, value)
SELECT t1.uid, SUM(t2.visits) as visits, SUM(t3.ads) as ads,
SUM(t3.value) as value
FROM {traffic_analytics_paths} AS t1
LEFT JOIN ( SELECT pid, date, SUM(count) AS visits

FROM {traffic_analytics_visits}
WHERE date > :start_date
GROUP BY pid

) t2 ON (t1.pid = t2.pid)

LEFT JOIN ( SELECT pid, date, SUM(count) AS ads, SUM(value)
AS value

FROM {traffic_analytics_ads}
WHERE date > :start_date
GROUP BY pid

) t3 ON (t1.pid = t3.pid)

GROUP BY t1.uid

[EX3]: Update User Statistics Over an Exemplary n-Day Period

UPDATE {traffic_analytics_users} as t
JOIN (

SELECT uid, value as revenue,

@w_prev := @w_curr as w_prev,
@w_curr := value as w_curr,
@w_rank := IF(@w_prev > @w_curr, @w_rank+@w_ties, @w_rank) AS

w_rank,

@w_ties := IF(@w_prev = @w_curr, @w_ties+1, 1) AS w_ties,
(1−@w_rank/@w_total ) as w_percentrank

FROM

{traffic_analytics_users},
(SELECT

@w_curr := null,
@w_prev := null,
@w_rank := 0,
@w_ties := 1,
@w_total := count(*) from traffic_analytics_users
WHERE value IS NOT NULL AND value > 0

AND ads IS NOT NULL AND ads > 0
AND visits IS NOT NULL AND visits > 0

) a
WHERE value IS NOT NULL AND value > 0

AND ads IS NOT NULL AND ads > 0
AND visits IS NOT NULL AND visits > 0

ORDER BY revenue DESC

) w ON w.uid = t.uid
JOIN (

SELECT uid, (value/ads) as cpm,

@x_prev := @x_curr as x_prev,
@x_curr := (value/ads) as x_curr,
@x_rank := IF(@x_prev > @x_curr, @x_rank+@x_ties, @x_rank) AS

x_rank,

@x_ties := IF(@x_prev = @x_curr, @x_ties+1, 1) AS x_ties,
(1−@x_rank/@x_total) as x_percentrank

FROM

{traffic_analytics_users },
(SELECT

@x_curr := null,
@x_prev := null,
@x_rank := 0,
@x_ties := 1,
@x_total := count(*) from traffic_analytics_users
WHERE value IS NOT NULL AND value > 0

AND ads IS NOT NULL AND ads > 0
AND visits IS NOT NULL AND visits > 0

) b
WHERE value IS NOT NULL AND value > 0

AND ads IS NOT NULL AND ads > 0
AND visits IS NOT NULL AND visits > 0

ORDER BY cpm DESC

) x ON x.uid = t.uid
JOIN (

SELECT uid, (ads/visits) as apv,

@y_prev := @y_curr as y_prev,
@y_curr := (ads/visits) as y_curr,
@y_rank := IF(@y_prev > @y_curr, @y_rank+@y_ties, @y_rank) AS

y_rank,

@y_ties := IF(@y_prev = @y_curr, @y_ties+1, 1) AS y_ties,
(1−@y_rank/@y_total) as y_percentrank

FROM

{traffic_analytics_users},
(SELECT

@y_curr := null,
@y_prev := null,
@y_rank := 0,
@y_ties := 1,
@y_total := count(*) from traffic_analytics_users
WHERE value IS NOT NULL AND value > 0

AND ads IS NOT NULL AND ads > 0
AND visits IS NOT NULL AND visits > 0

) c
WHERE value IS NOT NULL AND value > 0

AND ads IS NOT NULL AND ads > 0
AND visits IS NOT NULL AND visits > 0

ORDER BY apv DESC

) y ON y.uid = t.uid
JOIN (

SELECT uid, (visits/30) as activity,

@z_prev := @z_curr as z_prev,
@z_curr := (visits/30) as z_curr,
@z_rank := IF(@z_prev > @z_curr, @z_rank+@z_ties, @z_rank) AS

z_rank,

@z_ties := IF(@z_prev = @z_curr, @z_ties+1, 1) AS z_ties,
(1−@z_rank/@z_total) as z_percentrank

FROM

{traffic_analytics_users},
(SELECT

@z_curr := null,
@z_prev := null,
@z_rank := 0,
@z_ties := 1,
@z_total := count(*) from traffic_analytics_users
WHERE value IS NOT NULL AND value > 0

AND ads IS NOT NULL AND ads > 0
AND visits IS NOT NULL AND visits > 0

) d
WHERE value IS NOT NULL AND value > 0

AND ads IS NOT NULL AND ads > 0
AND visits IS NOT NULL AND visits > 0

ORDER BY activity DESC

) z ON z.uid = t.uid
SET t.score =
ROUND ((w.w_percentrank+x.x_percentrank+y.y_percentrank+z.z_percentrank
)*25, 0)
WHERE value IS NOT NULL AND value > 0

AND ads IS NOT NULL AND ads > 0
AND visits IS NOT NULL AND visits > 0

[EX4]: Calculating the Monetization Score Over an n-Day Period.

UPDATE traffic_analytics_users as t
JOIN (

SELECT uid, score as val,

@prev := @curr as prev,
@curr := score as curr,
@rank := IF(@prev > @curr, @rank+@ties, @rank) AS rank,
@ties := IF(@prev = @curr, @ties+1, 1) AS ties,
(1−@rank/@total) as percentrank

FROM

{traffic_analytics_users},
(SELECT

@curr := null,
@prev := null,
@rank := 0,
@ties := 1,
@total := count(*) from traffic_analytics_users where

score is not null and score > 0

) b
WHERE score is not null
ORDER BY score DESC

) u ON u.uid = t.uid
SET t.rank = ROUND (u.percentrank * 100.0)
WHERE score > 0

### [EX5]: Calculating the Percentile Rank of the Monetization Score

With the calculated monetization scores and ranks, one can utilize a probability distribution function to determine how to adjust certain factors in order to optimize monetization, or to predict a monetization score under certain conditions.

In probability theory and statistics, the Weibull distribution is a continuous probability distribution. W. Weibull developed a method and equation for statistically evaluating the fracture strength of materials. He also applied the method and equation to fatigue data based upon small sample (population) sizes, where the two-parameter expression relating life, L, characteristic life, L_{β} and probability of survival, S, is:

ln ln [1/S]=e ln [L/L_{β}], where 0<L<∞; 0<S<1

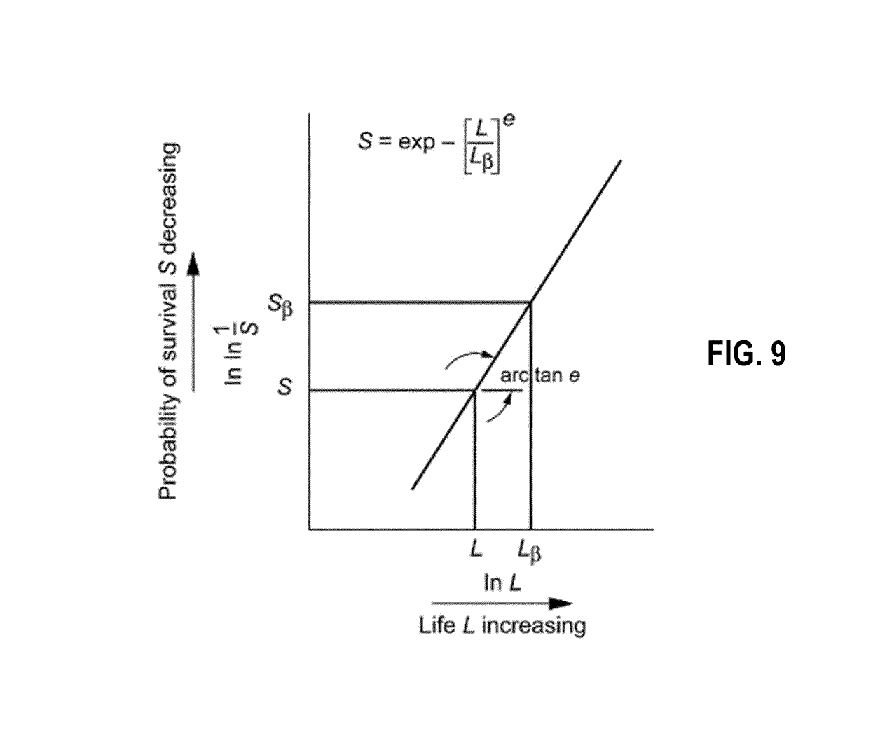

As can be seen from FIG. 9, when plotting the ln ln [1/S] as the ordinate against the ln L as the abscissa, fatigue data are assumed to plot as a straight line. The ordinate ln ln [1/S] is graduated in statistical percent of components failed or removed for cause as a function of ln L, the log of the time or cycles to failure. The tangent of the line is designated the Weibull slope e, which is indicative of the shape of the cumulative distribution or the amount of scatter of the data. The Weibull slope of the resultant Weibull plot approximates the statistical distribution of the data. As an example, a Weibull slope of 1 approximates an exponential distribution. A Weibull slope of 2 approximates a Raleigh distribution. A Weibull slope of 3.57 approximates a Gaussian or normal distribution. The resulting values of life compare reasonably well with other statistical distributions such as log normal. However, the ease of use and consistency of results offers an advantage of the Weibull method over these other distribution functions.

Using the Weibull method, one can determine for any given 30-day period what type of distribution to use for a particular test factor, as it is possible that these distributions may differ over time with changes in the population or the economy. Knowing this distribution factor, one can easily calculate the potential monetization score of an individual by simply adjusting certain factors. It can furthermore be utilized to advise individuals how to change certain factors to improve their score, such as by increasing daily activity, or focusing on specific websites that have shown to produce greater quality traffic.

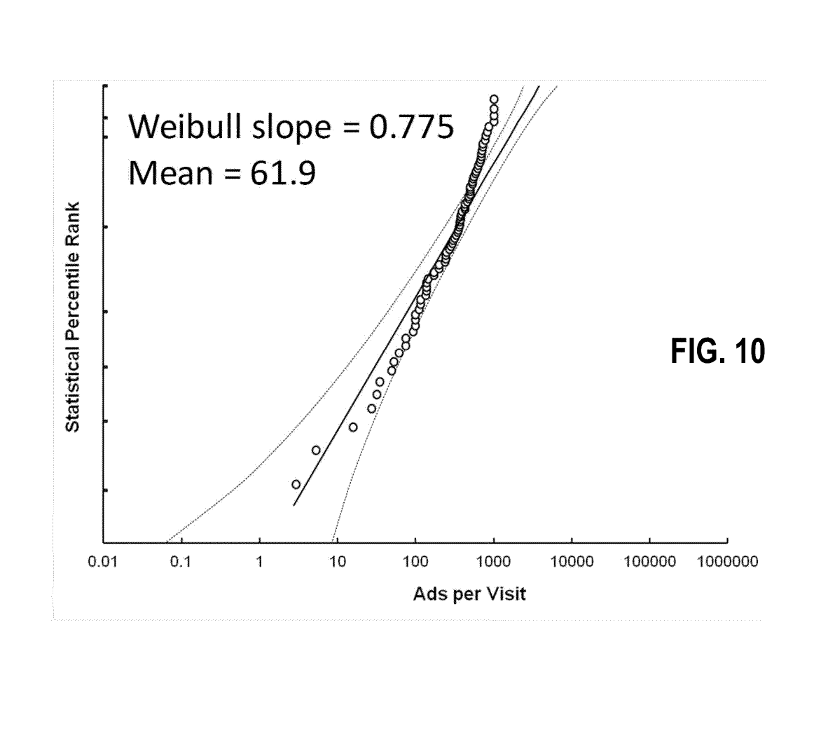

In FIG. 10, an exemplary Weibull plot for average ads per visit (APV) demonstrates a slope of 0.775 and statistical mean of 61.9 for the entire population. The daily statistical mean can be plotted in a line graph with the monetization score for each individual so they can view their performance with respect to others in the population. One can use the slope to calculate predicted scores based on changes in various test factors. For instance, one can then inform individuals that by increasing the number of ads per visit by n, it would increase their monetization score to Sₙ.

### (K) Multi-Level Referrals

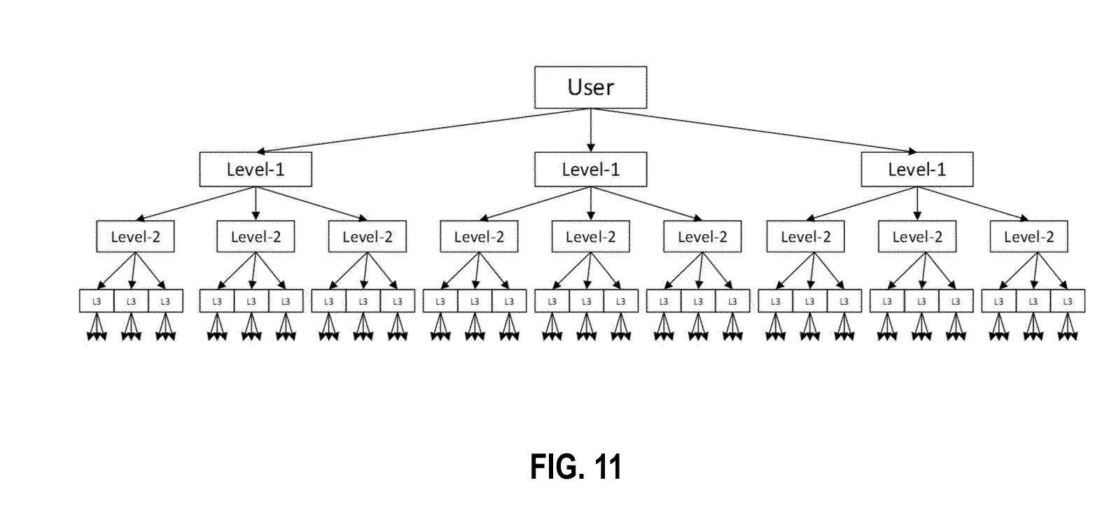

The system may include a multi-level referral database that can track the referrals from all users up to any number of levels. The multi-level referral tracks how a user joined the program through referral links, as illustrated in FIG. 11. A database may be used to store the relationship between referrals up to n levels, as required by the application. Table 17 below shows the fields for the database table to store up to 10 levels of referral relationships. The multi-level referrals works as follows under one exemplary embodiment:
1. A visitor clicks on a user's shortened link and is taken to the link shortener domain.
2. Before redirecting the client's browser, a cookie is dropped into the client's browser with the user's referral code and an expiration date, for example 30 days. The browser cookie is never overwritten; it is only replaced once it has expired.
3. If the visitor comes back to the link shortener domain and joins, the system downloads the cookie from the client browser and checks for a referral code. If a referral code is found, the user ID for the referral code is determined.
4. An entry is added to the multi-level referral table for the visitor (client) with ref_level1_uid set to the referrer user ID.
5. The n-level referral IDs of the user is obtained from the database, and loaded into positions 2 through n−1.
6. Each time a user generates revenue, a referral commission can be applied to any level of referrals by simply performing a database lookup.

TABLE 17
Database fields for Multi-Level Referrals

| | | | Not | Default |
|---|---|---|---|---|
| Field | Description | Type | Null | Value |
| uid | The UID of the user | int | TRUE | 0 |
| | who was invited | | | |
| max_level | The max allowable | int | TRUE | 0 |
| | levels for | | | |
| | monetizing | | | |
| created | UNIX timestamp | int | TRUE | 0 |
| | when user registered | | | |
| host | Network address | varchar(255) | TRUE | Empty |
| http_referrer | URL of the referring | varchar(255) | TRUE | Empty |
| | site | | | |
| ref_level1_uid | The level-1 referrer | int | FALSE | 0 |
| ref_level2_uid | The level-2 referrer | int | FALSE | 0 |
| ref_level3_uid | The level-3 referrer | int | FALSE | 0 |
| ref_level4_uid | The level-4 referrer | int | FALSE | 0 |
| ref_level5_uid | The level-5 referrer | int | FALSE | 0 |
| ref_level6_uid | The level-6 referrer | int | FALSE | 0 |
| ref_level7_uid | The level-7 referrer | int | FALSE | 0 |
| ref_level8_uid | The level-8 referrer | int | FALSE | 0 |
| ref_level9_uid | The level-9 referrer | int | FALSE | 0 |
| ref_level10_uid | The level-10 referrer | int | FALSE | 0 |

### Ad Serving Platform

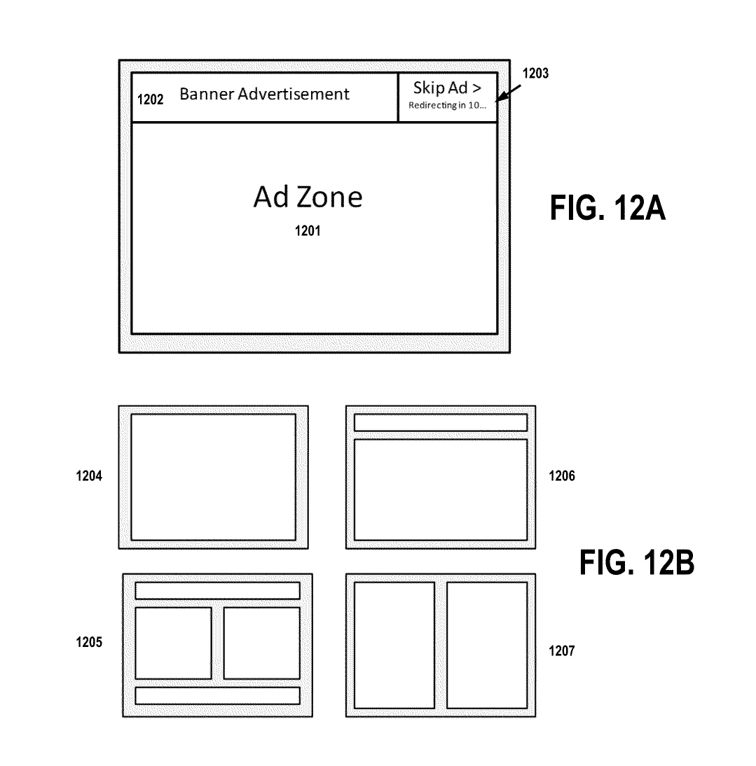

In one embodiment, when a visitor clicks on a shortened link, they are taken to a full-page advertisement. This is accomplished generally using an HTTP 301 or 302 redirect protocol. The advertisement page can be hosted on any domain or platform. FIG. 12A illustrates an example advertisement page. The top banner 1202 can be used to present the company logo or an advertisement to join the link shortening service. The banner may also include a Skip Ad button 1203 and a redirect countdown message. When clicked, or when the countdown expires, the user is redirected to the destination page using an HTTP 301 or 302 redirect protocol, or by changing the link in the client's browser address bar.

The main section of the advertisement page is the ad zone 1201, which is the section where ads are loaded. The ad zone can be compose of any HTML div, iframe, frame, or any other type that can load content dynamically or statically through client or server side scripts that alter the Document Object Model (DOM). As illustrated in FIG. 12B, the ad zone can load entire pages or dynamically configure the zone objects for various advertisement layout configurations (1204-1207). In some cases, depending on the number of ad impressions available and the total CPM, one configuration might be more preferable than another. The ad server determines the best configuration and notifies the ad page how to load the content.

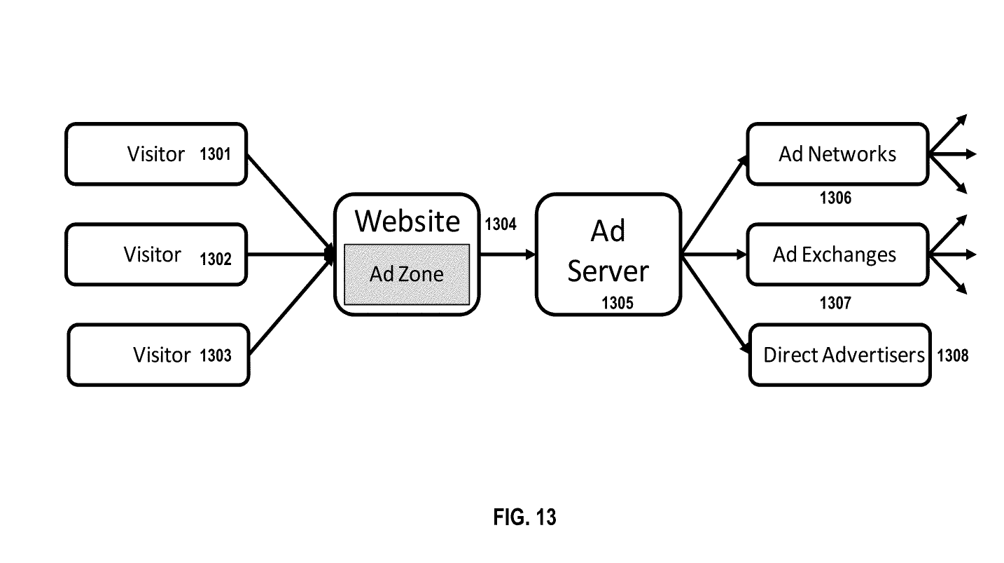

The ad server may be responsible for delivering and optimizing ad impressions displayed to visitors such that they produce the highest paying revenue (CPM). An exemplary ad serving methodology is described in the exemplary embodiment of FIG. 13. The ad server may acquire information about the user (1301-1303), including IP address, HTTP User Agent, and cookie data to identify the user. From this information, the client browser, operating system, geolocation, and hardware platform are derived. It also uses the context and metadata from the destination website, such as the title, description, keywords, and headers, to target relevant advertisements which generally have higher revenue potential. For instance, content about cars would target an ad impression related to car companies. The unique user ID of the owner (publisher) of the link is also passed to the ad server 1304 to facilitate branded advertisements for people of interest. The Ad Server processes this information 1305 and sends request to various ad networks 1306, ad exchanges 1307 and direct advertisers 1308 using a real-time-bidding system, where the highest bid(s) returned win. The Ad Server determines based on the bids returned the best configuration of the ad zone that maximizes the revenue potential. The configuration is sent to the website to dynamically load the ad impressions and layout. A client browser should have Javascript enabled in their browser and no ad blockers enabled for the content to load successfully. Upon loading the ad content, the website notifies the Ad Server of its success. Subsequently, the Ad Server logs the ad impression as a paid advertisement and the owner's account is credited. After several seconds, when countdown timer has reached zero, the visitor is redirected to the destination website.

The operations by the ad server include, but not limited to the following:
1. Use the content from the destination website, keywords, title, description, and categories to target advertisements based on the taxonomy, term, or category matching.
2. Target advertisements based on the specific unique user ID, which is the owner of the shortened link. This facilitates branded advertisements for celebrities, athletes and other persons of interest.
3. Determine from the User Agent if the client browser is on a mobile platform that requires mobile size advertisements.
4. Track visitors with cookies containing a unique ID, which is dropped by the link shortener before redirecting to the advertisement page. The cookie never expires and is never overwritten. The cookie's unique ID along with the IP address is stored in a database, which is used for frequency capping, to ensure an advertisement is not shown to the same visitor more than a specified amount.
5. Determine from the User Agent if the client browser or operating system are undefined, if the client is a web crawler or bot, or if the client is behind a proxy server. Advertisements are not shown in these cases and client is redirected to the destination page.
6. Dynamically create DOM element and pixel tracking to determine if the Javascript is enabled. If not, it is a sign that the client might be a program not operating through a browser. Advertisements are not shown in this case.
7. Geo-IP location lookup is used for targeting advertisements to specific regions.

To meet the effective bandwidth requirements to process ad requests at this level of speed, the Ad Server algorithm was designed to utilize multi-threaded parallel processing methods. This allows the system to communicate with multiple platforms concurrently, as opposed to sequentially waiting for each one to return a value before proceeding to the next one.

### (L) Targeted Advertisements

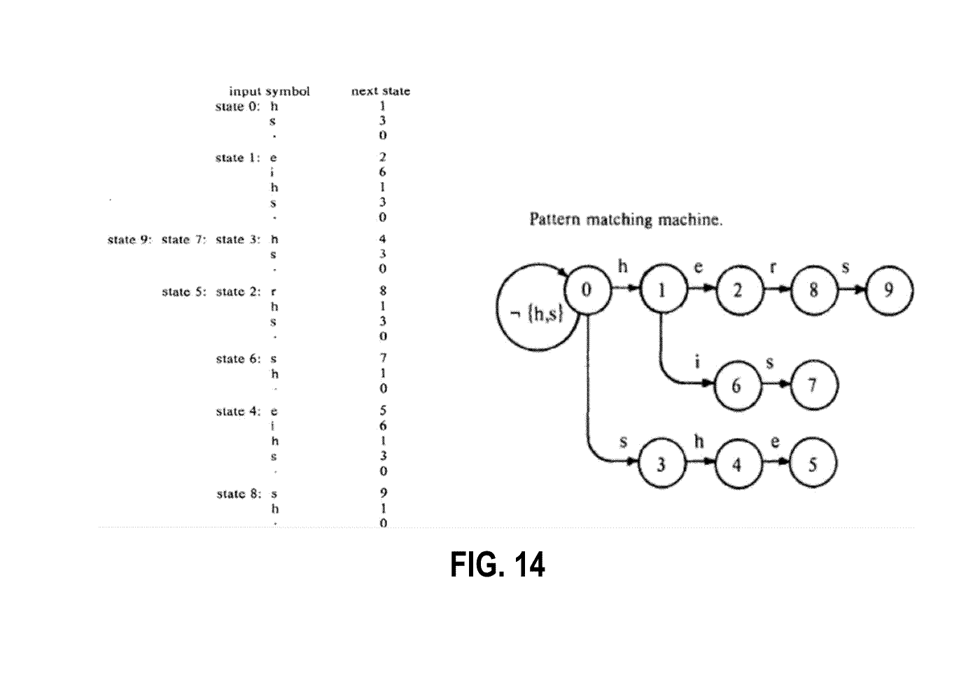

The link data, including title, description, keywords, and headers can be parsed to determine categories and keywords that of interest to advertisers. In one exemplary embodiment, using string matching based on the Aho-Corasick pattern matching algorithm in FIG. 14, one may apply finite-state-machine lookup tables to match patterns in linear time. The algorithm uses a database to match keywords to categories in order to determine the context of the data. The categories and keywords can then be passed to the ad serving platform to target advertisements for a particular link, or one can track users with cookies that suggest they have an interest in context about those subject matters. For instances, if the context of the destination page was about cars, the ad server can promote car advertisements. A cookie would then be dropped in the client's browser assigning categories=cars.

In statistics, Bayesian inference is a method of inference in which Bayes' theorem is used to update the probability estimate for a hypothesis as additional evidence is learned. What Bayes' theorem clearly demonstrated is that the more information given, the more accurate the view of the world will be, and prior experience should be used to inform new data. In a typical problem, such as judging the relevance of content to a given query, Bayesian theory dictates that this calculation be related to details that are already known. In a similar manner, knowledge about the content deemed relevant by a user can also be used in judging the relevance of future context or documents. In true Bayesian fashion, one begins with an empty data set and let the incoming data dictate the model. The new information is mixed with a growing body of older content to refine and retrain the engine.

Natural languages contain a high degree of redundancy or nonessential content. For example, the essence of a news article can be grasped simply by skimming over the text. Shannon's Information Theory provides a framework for extracting the essential concepts from this redundancy, and serves as a mathematical foundation for all digital communications systems. The theory implies that the less frequently a unit of communication occurs, the more information it conveys. Therefore, ideas, which are rarer within the context of a communication, tend to be more indicative of its meaning. It is this theory that enables a content search engine to determine the most important, or informative, concepts or terms within the context of a document.

Applied to the task of information filtering, the idea is that the odds of a content being relevant to the topic profile is determined using a generative probabilistic language model. If the content scores above a user defined threshold then it is considered relevant to the topic profile. Content can be modeled as a bag of words consisting of terms t and the frequency f of occurrences of the term within the document. The term t can refer to a single word or a fixed sequence of words, or n-gram. A Bayesian algorithm can be computed offline to determine a set of weights w for each term, generally based on the frequency of occurrence in the natural language. The more frequent the term appears in the language, the lower the weight. For instance, the word occurs so often in the English language that it would have a very small weight. One way to calculate the weights would be to use a natural language processing learning machine to analyze a large number of documents and determine the frequency of the terms it encounters in the natural language. These weights can then be programmed in a parser to determine how relevant the content is in accordance with the search query. The score of a given content can be calculated as the summation of the frequency of occurrence of each term in the content, multiplied by its weight.

In this ad targeting technology, one may parse the terms and words from the content of each destination link, title, description, keywords, and headers. One can then match the words to a database to quickly accumulate the frequency of occurrence for each individual word or n-gram. The low-frequency words can be extracted automatically and used for categorizing the context of the destination page and for optimizing targeted advertisements.

Advertisements are also targeted by matching the unique user ID. The unique user ID of the owner (publisher) of the link is passed to the ad server during the redirect process in order to facilitate branded advertisements for people of interest. When a match is found, a branded ad campaign may take precedence over all other ad campaigns, regardless of a higher CPM bid from other ad networks or exchanges.

Furthermore, the demographics for celebrities and other persons of interest are generally more well-defined. For example, a female singer/songwriter would statistically have a larger audience composed of females in a particular age range. One may utilize these statistics to profile the visitors, target specialize advertisements for those demographics, or apply the information to cookie tracking to acquire more analytical data in the future.

### (M) Security Features

The system may comprise several security features to prevent abuse from users who artificially inflate traffic to generate more revenue, target unsuspecting people with viruses or Trojans, or share illegal and inappropriate content. These security features monitor the behavior and data from incoming and outgoing traffic, and the contents of the destination. The following descriptions include, but are not limited to those security features employed:
1. Real-time threat protection against malicious sites containing viruses, Trojans or malware. A third party tool or database can be used to obtain real-time statistics on any domain or webpage. For external queries to third-party tools, such as anti-virus solutions, a real-time database can be used to cache daily requests in order to avoid repeated external queries. If an active threat is found on a domain or page, the redirect to that page is prevented. Instead, visitors are notified that the page has been blocked.
2. Real-time protection against inappropriate material, adult content, illegal content, or potentially unsafe destinations. When a shortened link is created or edited, the meta data from the destination page is downloaded, including title, description, keywords, images, videos, and headers. The content is parsed and matched against specific keywords, such as those used in adult material. Images and videos can also be analyzed through learning machines, pattern matching algorithms, or skin detection algorithms to identify adult content, nude regions, or other inappropriate material. If one or more matches are found, the link can be flagged or blocked. Redirects to that page are prevented, and visitors are notified that the page has been blocked. Likewise, links to other URL shorteners can be blocked since their destinations can be altered without the ability to protect visitors.
3. Real-time protection for traffic sources whose referring website domain or IP address originates from particular traffic-exchanges or other illegal sources. In such cases, these addresses can be blocked from seeing advertisements. Likewise, IP addresses from particular proxies, countries, or users can be blocked from seeing advertisements and generating ad revenue. The IP addresses and domain names can be stored in a local database and quickly retrieved.
4. Proxy server detection, which is used to hide the true IP address and browser of the visitor. This is the typical method for software programs to exploit traffic, since the proxy server can flush out all session cookies and change its IP address instantaneously making it seem like a new visitor. Proxy servers can be detected by the existence of HTTP headers, such as HTTP_VIA, HTTP_FORWARDED, HTTP_USERAGENT_VIA, and HTTP_X_FORWARDED_FOR. However, some proxies do not abide by these standards. Other ways of detecting proxies is by querying third-party databases for known proxy servers.
5. Cookie tracking is used to identify those visitors who utilize hidden proxies or software programs to generate traffic. One may store previous IP addresses into a tracking cookie that is deposited in the client's browser. If not flushed, when the cookie is read back one can determine if the IP address had changed in a short period of time. This is a clear indication that a proxy is being used or the IP address is being altered by a software program. The use of zombie cookies, or ever-cookies, can also be employed to track a user more thoroughly. This is accomplished by storing the cookie data in several types of storage mechanisms that are available on the local browser. If any of the data is ever lost, the data can be recovered and then reset and reused.
6. Behavior monitoring is used to identify whether a software program is being used to generate traffic. Generally software programs are very precise in the time between traffic hits. If a consistent pattern is identified, it is an indication of a software program. Illegal behavior can also be identified by looking at the traffic analytics.
7. Generally, an imbalanced number of operating systems, browsers, or no referring websites is an indication that a software program is being used to generate the traffic. Traffic patterns from social media sites have a very distinct characteristic. If a link has a large number of referrers from a particular social media site, but the traffic pattern does not fit the standard traffic pattern, it can be flagged as well.
8. Traffic patterns that show a large number of visits but very little advertisements is an indication that Javascript is not running on the client browser. This can indicate that a software program or web crawler is generating the traffic because they cannot execute Javascript code outside a web browser.
9. If a user is found to abuse the system, advertisements can be disabled for the all links on the account.

### (N) Hosted Content

URL shortening is a technique where a long URL can be made substantially shorter in length by mapping the long URL to a shorter URL, constructed with a tag consisting of a few characters or a custom set of characters. The shortened URL can point to any content that is accessible on the web, including but not limited to websites, programs, files, locations, music, photos, videos, and movies. The content can also be hosted by the link shortener platform. In one embodiment, the user can upload files, music, photos, and videos onto the link shortener's hosted server or on a hosted cloud platform, where it is accessible on the web. Upon upload of the content, a shortened link is returns for the address of the content, which can be shared anywhere or with anyone. When a visitor clicks on the link, they are shown an advertisement, and then redirected to the content on the link shortener's hosted server or cloud platform. Like other social media, the content can be managed and organized into folders or groups. They can be tagged and assigned titles, descriptions, dates, and other meta information.

In another exemplary embodiment, the user can upload files, music, photos, and videos onto the link shortener's hosted server or onto the link shortener's hosted cloud platform, where it is accessible on the web. Upon upload of the content, a shortened link is returned for the address of the content, which can be shared anywhere or with anyone. When a visitor clicks on the link, they are shown an advertisement, and then redirected to the content on the link shortener's hosted server or cloud platform.”

### (O) Application Programming Interface

The application programming interface (API) under one embodiment is a platform that allows developers to integrate link shortening with web services, mobile apps, and other third-party tools. The API may integrate with a Personal API Key, so that links can be shortened remotely without providing a username or password to third-parties. The Personal API Key is generated automatically and stored in a database with the user ID. The user ID can be retrieved with a simple database query:
SELECT uid FROM table WHERE apikey=:apikey.

The API allows one to shorten, customize, or expand a URL using a simple query command. To allow custom integration with a variety of platforms, the API can return query results in different formats, including but not limited to text, PHP, XML and JSONP. When an API command is executed, the system first retrieves the user ID from the API key table. If the user ID exists, it shortens or expands the link according to the parameters specified as can be seen in Table 18 below, and returns the value the format specified. The following sections describe API commands for shortening and expanding links.

### (P) Exemplary Shortening API

http://snip.ps/api/shorten?api_key=[API_KEY]&format=[FORMAT] &url=[URL]

### Example:

http://snip.ps/api/shorten?api_key=8b5df8fba04797dd1074c3ecbd1d2ab7&format=txt&url=http://www.example.com

### Returns:

http://snip.ps/ccd

### Standard Shortening API With Custom Tag

http://snip.ps/api/shorten?api_key=[API_KEY]&format=[FORMAT]&url=[URL]&custom=[CUSTOM_TAG]

### Example:

http://snip.ps/api/shorten?api_key=8b5df8fba04797dd1074c3ecbd1d2ab7&format=txt&url=http://www.example.com&custom=mytag

### Returns:

http://snip.ps/mytag

### Standard Expanding API

http://snip.ps/api/expand?api_key=[API_KEY]&format=[FORMAT]&url=[URL]

### Example:

http://snip.ps/api/expand?api_key=8b5df8fba04797dd1074c3ecbd1d2ab7&format=txt&url=http://snip.ps/ccd

### Returns:

http://www.example.com

TABLE 18
API parameters

| Parameter | Description |
|---|---|
| api_key | This is the Personal API key that is provided to the user. The |
| | API key can be safely shared with third-party web services |
| | and tools. |
| format | This is the format of the output from the API query. Valid |
| | format types are: |
| | txt—Text format that returns just the short URL (default) |
| | php—PHP serialized array |
| | xml—XML format |
| | jsonp—Lightweight JSON data-interchange format. JSONP |
| | may take an additional callback argument (optional). |
| callback | This is the name of callback function argument for a JSONP |
| | request. |
| url | This is the URL path to be shortened or expanded. |
| ads | Enable or disables display advertisements for a particular |
| | URL link. Valid parameters are: |
| | on—Enables display advertisements that appear each time a |
| | URL is clicked. |
| | off—Disables display advertisements from appearing when a |
| | URL is clicked. |
| custom | This is a custom short URL tag that you may provide |
| | (optional) when shortening a URL. By default, a short URL |
| | tag is automatically generated. |

### (Q) Bookmarklet

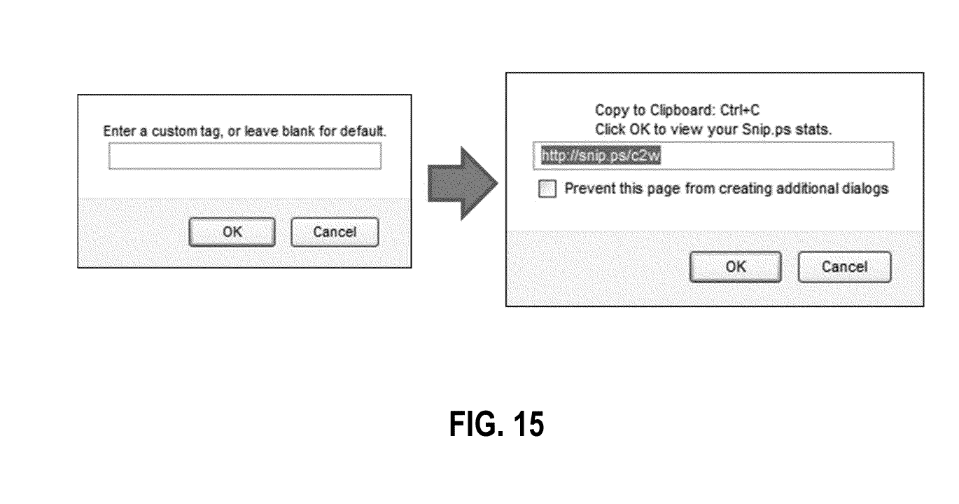

A bookmarklet is a bookmark stored in a web browser that contains JavaScript commands to extend the browser's functionality. The bookmarklet presented in FIG. 15 allows users to shorten links remotely without leaving the current website. It requests a custom tag from the user in a dialogue box, which can be left blank to use a default shortened tag. The link shortener returns the shortened link in a new dialogue box, which can be copied to your clipboard. By clicking OK, the statistics page for the link is opened in a new browser window.

In one embodiment, the bookmarklet is built on top of the API with the JSONP callback functionality. The bookmarklet Javascript code is presented in [EX6] below. It passes the user's Personal API Key to the remote AJAX bookmarklet API code presented in [EX7], and then appends the script the DOM of the current page so it may be executed. The API code simply shortens the link with the Personal API Key, then executes a callback function, passing the returned shortened link to the user.

javascript:(function( ){

var script=document.createElement(“script”);
script.type=“text/javascript”;
script.src =

“http://snip.ps/bookmarklet.js?api_key=8b5df8fba04797dd1074c3ecbd1d2ab
7”;
document.getElementsByTagName(“body”)[0].appendChild(script);void(0);
})( );

### [EX6]: Javascript Web Browser Bookmarklet Code.

(function( ) {

function get_arg(v)
{

var scripts = document.getElementsByTagName(‘script’);
var script = scripts[ scripts.length − 1 ];
var requestURL = script.getAttribute(“src”);
var query = requestURL.substring(requestURL.indexOf(“?”) + 1,

requestURL.length);

var vars = query.split(“&”);
for ( var i=0; i<vars.length; i++ )
{

var pair = vars[i].split(“=”);
if ( pair[0] == v )
{

return unescape(pair[1]);

}

}
return “”;

}
function snip_it (api_key, url, tag, title, callback)
{

var custom = (tag != “”) ? (“&custom=” +

encodeURIComponent(tag)) : “”;

var t = (title != “”) ? (“&title=” +

encodeURIComponent(title)) : “”;

var callbackFuncName = “snipps_callback”;
var script = document.createElement(“script”);
script.setAttribute(“type”, “text/javascript”);
script.setAttribute(“id”, “snipps_bookmarklet_js”);
script.setAttribute(“src”,

“http://snip.ps/api/shorten?api_key=”+api_key+“&format=jsonp&url=”+enc
odeURIComponent(url)+“&callback=window.”+callbackFuncName+custom+t);

window[callbackFuncName] = function(data){

script.parentNode.removeChild(script);
window[callbackFuncName] = null;
try {

delete window[callbackFuncName];

} catch(e) { }
callback(data);

};
document.getElementsByTagName(“head”)[0].appendChild(script);

}
var tag = window.prompt(“Enter a custom tag, or leave blank for

default.”, “”);

if ( tag == null ) return;
snip_it(get_arg(“api_key”), location.href, tag, document.title,

function(data) {

if ( data.success == true ) {

var snip_url = data.shortUrl;
var response = window.prompt(“Copy to Clipboard:

Ctrl+C\nClick OK to view your Snip.ps stats.”, snip_url);

if ( response != null ) {

var stats_url = snip_url.replace(“snip.ps/”,

“snip.ps/statistics?path=”);

var win = window.open(stats_url, “_blank”);
if ( win == null ) {

try {

var a = window.document.createElement(“a”);
a.target = ‘_blank’;
a.href = stats_url;
var e =

window.document.createEvent(“MouseEvents”);

e.initMouseEvent(“click”, true, true, window,

0, 0, 0, 0, 0, false, false, false, false, 0, null);

a.dispatchEvent(e);

} catch(e) {

location.href = stats_url;

}

}

}

}
else {

alert ( “Snip.ps Error: ” + data.error );

}

});

})( );

### [EX7]: Javascript/AJAX Bookmarklet API Code

### (R) Tools

In certain embodiments, additional tools can be integrated with the link shortening monetization system and with the API. Some examples of tools include, but are not limited to:
1. Redirect Links—This API allows one to simply redirect a visitor to the ad page, and then to destination site after the ad is skipped. There is no need to shorten links. For example, the link http://snip.ps/redirect?uid=1234&path=www.google.com will redirect to www.google.com after the ad is skipped. The user earns revenue from the advertisement shown.
2. Replace All Links Script—Using the Redirect Links API above, this script uses AJAX to replace all external links or those that do not match specified domains to redirect to the ad page. The redirect address on the ad page will point to the destination address.
3. Entry Ad Script—Placing this script on a web page will check the URL address of web browser upon entry by a visitor for a no-redirect parameter. If not set, it will redirect the visitor to the ad page. The redirect address on the ad page will point back to the home page with the additional no-redirect parameter set to true. This will ensure the visitor is no longer redirected to the ad page.

### (S) Games

The concept of a URL shortner that pays through advertisement can be extended to games, or competitions between two or more players. This concept includes any form of competition or game where the player(s) receive compensation from advertising revenue or other consideration paid by advertisers for the traffic they generate in the context of the game or competition.

An example of such a game is where one or more players compete to generate the most revenue or traffic on shortened links. Each player shares a shortened link to the same (or different) website destination for a specified period of time, or until a specific goal is reached. At the conclusion of the competition, the player(s) with the highest traffic or advertising revenue keep (or split) all revenue from all players in the competition. This can be extended to include referral traffic and revenue. The concept is further extended to any video game, board game, or digital media game where players can earn money through the advertising revenue.

It should be understood by those skilled in the art that the disclosure provided herein provides advantages over existing computer system. Again, it should be understood by those skilled in the art that the present disclosure is being provided for the purposes of illustration only, and should not be construed as limiting the present disclosure to the specific embodiments described. While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the invention in any way. Rather, the foregoing detailed description will provide those skilled in the art with a convenient and edifying road map for implementing the described embodiment or embodiments. as the following claims reflect, inventive subject matter lies in less than all features of a single disclosed embodiment. Thus the following claims are hereby incorporated into the Detailed Description, with each claim standing on its own as a separate embodiment.

What is claimed is:

1. A processor-based method for shortening a first link having a first length, wherein the first link comprises data relating to content at a destination network address in a network, the method comprising:
receiving and generating characteristic data relating to the content and the destination network address;
validating the characteristic data;
processing the characteristic data to establish one or more categories for the content of the characteristic data;
generating a tag associated with the first link;
processing the first link to form a second link having a second length and comprising the generated tag, wherein the second length is shorter than the first length.

2. The processor-based method according to claim 1, wherein the characteristic data comprises metadata and HMTL subject headers.

3. The processor-based method according to claim 2, wherein the characteristic data comprises at least one of (1) a unique record ID, (2) a user ID, (3) a source path, (4) a redirect URL, (5) timestamp of creation, (6) timestamp of last use, (7) keywords describing the content at the destination network address, (8) a title for the destination network address, (9) a description of the destination network address, and (10) one or more images or videos at the destination network address.

4. The processor-based method according to claim 3, wherein advertisement data is identified based on the established categories.

5. The processor-based method according to claim 4, wherein the identification of the advertisement data is performed utilizing string matching.

6. The processor-based method according to claim 5, wherein the string matching comprises an Aho-Corasick pattern matching, Bayesian inferencing pattern matching, or natural language processing algorithms.

7. The processor-based method according to claim 1, wherein receiving the characteristic data is performed via an asynchronous multi-threaded process.

8. The processor-based method according to claim 1, further comprising the step of validating the tag prior to forming the second link.

9. The processor-based method according to claim 1, wherein validating the characteristic data comprises determining (i) if the content at the destination network address contains prohibited characteristic data, or (ii) if the destination network address is from a prohibited address.

10. The processor-based method according to claim 1, further comprising the step of transmitting the second link to a user via the network.

11. A processor-based method for processing a shortened link relating to content at a destination network address in a network, the shortened link comprising a tag, the method comprising:
receiving activation data for the shortened link from a user address in the network;
extracting the tag from the shortened link;
determining the destination network address for the content from the extracted tag;
verifying the destination network address for the content;
transmitting a cookie to the user address;
assigning identification data for the received activation data; and
redirecting the activation data to an intermediary address that is associated with the destination address for the content;

12. The processor-based method of claim 11, wherein the intermediary address comprises advertising content.

13. The processor-based method according to claim 12, wherein determining the destination network address comprises processing the tag to determine characteristic data.

14. The processor-based method according to claim 13, wherein the characteristic data comprises at least one of (1) a unique record ID, (2) a user ID, (3) a source path, (4) a redirect URL, (5) timestamp of creation, (6) timestamp of last use, (7) keywords describing the content at the destination network address, (8) a title for the destination network address, (9) a description of the destination network address, and (10) one or more images or videos at the destination network address.

15. The processor-based method according to claim 14, wherein advertising content is identified based on the characteristic data.

16. The processor-based method according to claim 15, wherein processing the tag comprises identification of advertising content utilizing string matching.

17. The processor-based method according to claim 16, wherein the string matching comprises an Aho-Corasick pattern matching process, Bayesian inferencing pattern matching process, or natural language processing algorithms.

18. The processor-based method of claim 12, further comprising the step of obtaining and storing user information from the user address.

19. The processor-based method of claim 18, further comprising the step of obtaining and storing content information relating to the content at the destination network address.

20. The processor-based method of claim 19, further comprising the step of subjecting the user information and content information to analytics processing.
